(19) United States
(12) Patent Application Publication
(10) Pub. No.: US 2016/0314501 A1
(43) Pub. Date: Oct. 27, 2016

(54) SCALABLE NETWORKED COMPUTING SYSTEM FOR SCORING USER INFLUENCE IN AN INTERNET-BASED SOCIAL NETWORK

(71) Applicant: MXM Nation Inc., Toronto (CA)

(72) Inventors: Myles BARTHOLOMEW, Waterloo (CA); Gary BARTHOLOMEW, Mississauga (CA); Seth BROUWERS, Burlington (CA)

(21) Appl. No.: 15/078,258

(22) Filed: Mar. 23, 2016

Related U.S. Application Data
(60) Provisional application No. 62/137,701, filed on Mar. 24, 2015.

(51) Int. Cl. G06Q 30/02

(52) U.S. Cl. CPC G06Q 30/0275; G06Q 50/01

(57) ABSTRACT

A scalable networked computing system scores social influence in an Internet-based social network. The system includes: a storage for storing user records and sponsor records. Each user record includes a user identifier, a user's quantity of credits, and at least one score relating to the user's social network influence. Each sponsor record includes a sponsor identifier, a quantity of sponsor-purchased credits, and at least one score relating to the sponsor's social network influence. A networked interface receives from the user a redemption offer, which is open for bids from at least one sponsor. A processor performs a valuation of the redemption offer to determine an adjusted value for the quantity of credits based on at least one user score and returning the adjusted value to the user and/or the at least one sponsor prior to prompting a bid from the at least one sponsor.

### BACKGROUND OF THE INVENTION

1. Field of the Invention

The present invention relates to a scalable networked computing system that is responsive to user actions in an Internet-based social network, and more particularly to such a system for scoring user influence in an Internet-based social network.

2. Description of the Related Art

Powered by such tools as email, weblogs, bulletin boards, chat rooms, streaming video, image uploads and instant messenger, computer-networked communication has given rise to different types of online communities or social networks. Online users form or join social networks for different reasons such as information exchange, friendship, social support, and recreation. The rapid growth of social networking platforms such as MySpace, Facebook, LinkedIn, Twitter, Google+, Instagram, YouTube, Flickr, Blogger, Tumblr, and the like is evidence of a multiplier effect of online computer-networked communication as online users share profiles, likes, dislikes, photos, videos, music, posts, comments, contacts and the like with friends and strangers.

The potential for consumer-to-consumer marketing within the online communication of social networks has been recognized. Several systems for rewarding online referrals of goods or services have been proposed including those disclosed in U.S. Pat. No. 6,289,318 (issued 11 Sep. 2001), U.S. Pat. No. 7,568,004 (issued 28 Jul. 2009), U.S. Pat. No. 7,664,726 (issued 16 Feb. 2010), U.S. Pat. No. 8,306,874 (issued 6 Nov. 2012) and US Patent Publication Nos. 2008/0010139 (published 10 Jan. 2008), 2011/0208572 (published 25 Aug. 2011), 2011/0313832 (published 22 Dec. 2011), 2012/0278146 (published 1 Nov. 2012) and 2013/0166364 (published 27 Jun. 2013). However, no referral reward system has yet been widely adopted for computer network mediated marketing purposes. One problem may be that existing referral reward systems are typically practiced by individual companies allocating points under a single reward scheme and are not easily scaled up to include multiple companies allocating points under multiple reward schemes. Another problem may be that in existing systems redemption of points are typically limited to products from a specific company or clearinghouse linked to the original issuer of points and does not readily accommodate redemption of points to obtain products from an independent company.

Accordingly, there is a continuing need for a system and method to facilitate redemption of credits accumulated in computer-mediated social networks.

### SUMMARY OF THE INVENTION

In an aspect there is provided a scalable networked computing system for scoring social influence in an Internet-based social network comprising:

a storage system for storing a plurality of user records and a plurality of sponsor records, each user record comprising a user identifier and a quantity of credits allocated to the user and at least one score relating to the user's social network influence and each sponsor record comprising a sponsor identifier, a quantity of sponsor-purchased credits and at least one score relating to the sponsor's social network influence;

a networked interface device for receiving from the user a redemption offer for a quantity of credits held in the user's account, the redemption offer open for bids from at least one sponsor; and

a processor for performing a valuation analysis of the redemption offer to determine an adjusted value for the quantity of credits based on at least one user score and returning the adjusted value to the user and/or the at least one sponsor prior to prompting a bid from the at least one sponsor.

In another aspect there is provided a system for a scalable networked computing system for scoring social influence in an Internet-based social network, comprising:

a storage system for storing a plurality of user records and a plurality of sponsor records, each user record comprising a user identifier and a quantity of credits allocated to the user and at least one score relating to the user's social network influence and each sponsor record comprising a sponsor identifier, and at least one score relating to the sponsor's social network influence;

a networked interface device for receiving from a user a redemption offer for a quantity of credits held in the user's account, the redemption offer directed to at least one sponsor; and

a processor for performing a valuation analysis of the redemption offer to determine an adjusted value for the quantity of credits based on at least one user score and returning the adjusted value to the user, the at least one sponsor or both the user and the at least one sponsor.

In yet another aspect there is provided a method for scoring social influence in an Internet-based social network, comprising:

storing a plurality of user records, each user record comprising a user identifier and a quantity of credits allocated to the user and at least one score relating to the user's social network influence;

storing a plurality of sponsor records, each sponsor record comprising a sponsor identifier, a quantity of sponsor-purchased credits and at least one score relating to the sponsor's social network influence;

receiving from a user a redemption offer for a quantity of credits held in the user's account, the redemption offer open for bids from at least one sponsor; and

performing a valuation analysis of the redemption offer to determine an adjusted value for the quantity of credits based on at least one user score and returning the adjusted value to the user and/or the at least one sponsor prior to prompting a bid from the at least one sponsor.

In still another aspect there is provided a method for scoring social influence in an Internet-based social network, comprising:

storing a plurality of user records, each user record comprising a user identifier and a quantity of credits allocated to the user and at least one score relating to the user's social network influence;

storing a plurality of sponsor records, each sponsor record comprising a sponsor identifier and at least one score relating to the sponsor's social network influence;

receiving from a user a redemption offer for a quantity of credits held in the user's account, the redemption offer open for bids from at least one sponsor; and

performing a valuation analysis of the redemption offer to determine an adjusted value for the quantity of credits based on at least one user score and returning the adjusted value to the user, the at least one sponsor or both the user and the at least one sponsor.

In still a further aspect there is provided a computer readable medium embodying a computer program for scoring social influence in an Internet-based social network, comprising:

computer program code for storing a plurality of user records, each user record comprising a user identifier and a quantity of credits allocated to the user and at least one score relating to the user's social network influence;

computer program code for storing a plurality of sponsor records, each sponsor record comprising a sponsor identifier and at least one score relating to the sponsor's social network influence;

computer program code for receiving from a user a redemption offer for a quantity of credits held in the user's account, the redemption offer open for bids from at least one sponsor; and

computer program code for performing a valuation analysis of the redemption offer to determine an adjusted value for the quantity of credits based on at least one user score and returning the adjusted value to the user and/or the at least one sponsor prior to prompting a bid from the at least one sponsor.

In a further aspect there is provided a computer readable medium embodying a computer program for scoring social influence in an Internet-based social network, comprising:

computer program code for storing a plurality of user records, each user record comprising a user identifier and a quantity of credits allocated to the user and at least one score relating to the user's social network influence;

computer program code for storing a plurality of sponsor records, each sponsor record comprising a sponsor identifier, a quantity of sponsor-purchased credits and at least one score relating to the sponsor's social network influence;

computer program code for receiving from a user a redemption offer for a quantity of credits held in the user's account, the redemption offer open for bids from at least one sponsor; and

computer program code for performing a valuation analysis of the redemption offer to determine an adjusted value for the quantity of credits based on at least one user score and returning the adjusted value to the user, the at least one sponsor or both the user and the at least one sponsor.

### BRIEF DESCRIPTION OF THE DRAWINGS

FIG. 1 shows a block diagram describing a flow example of a user interaction with a sponsorship management system;

FIG. 2 shows a block diagram describing a flow example of a sponsor interaction with the sponsorship management system;

FIG. 3 shows a block diagram describing a flow example of a user action monitoring component of the sponsorship management system;

FIG. 4 shows a block diagram describing a flow example of a user interaction with the sponsorship management system to transition from a first discount level to a second discount level;

FIG. 5 shows a block diagram describing a flow example of a user and a sponsor interaction with a system for scoring social influence in an Internet-based social network working in combination with the sponsorship management system;

FIG. 6 shows a block diagram describing a flow example of a user interaction and an interaction of a plurality of sponsors with a system for method for scoring social influence in an Internet-based social network working in combination with the sponsorship management system;

FIGS. 7A and 7B show system map schematics describing illustrative implementations of the system for scoring social influence in an Internet-based social network;

FIG. 8 shows a block diagram describing an example of a credit converter component of the sponsorship management system;

FIG. 9 shows a block diagram describing a flow example of a sponsor allocating credits to a user;

FIG. 10 shows a block diagram describing a flow example of a user leveraging credit holdings to unlock a desired feature of the sponsorship management system;

FIG. 11 shows a block diagram describing a flow example of tracking a transfer of credits from sponsor to user;

FIG. 12 shows a block diagram describing a flow example of tracking a redemption of credits by a user;

FIG. 13 shows a block diagram describing a flow example of tracking a purchase of credits by a sponsor or user.

### DETAILED DESCRIPTION OF PREFERRED EMBODIMENTS

A system for scoring social influence in an Internet-based social network, or method for providing the same, includes each of a plurality of sponsors purchasing credits from an administrator and allocating the purchased credits to users for actions that endorse a sponsor. Each credit may be associated with several identifiers including an identifying code and an identifier relating to the current owner of the credit. Typically, each transaction or transfer of each credit will be tracked and registered such that the transactional history of each credit may be documented. Redemption of user credits to a sponsor may be facilitated by providing a valuation of a quantity of credits as a function of a user score, a sponsor score, or both a user score and a sponsor score.

A typical sponsor may be any legal entity having a vendible product (ie., a good and/or a service) and wishing to reward user actions that endorse or promote a sponsor's name, products, activities and the like by providing the user with credits that can be accumulated to yield a discount for purchasing the sponsor's product(s). Typically, a plurality of sponsors will participate in the sponsorship management system.

A typical user may be any individual or legal entity, including for example individual consumers, groups or associations of individuals, or businesses, that wish to purchase a product (ie., a good and/or a service) from one or more of a plurality of sponsors participating in the sponsorship management system.

The system may allow users an immediate benefit of membership in the system by providing upon enrollment a base discount level for purchasing one or more products of participating sponsor(s).

The system may allow for a transparent scheme for sponsors to reward promotional actions such as endorsements, testimonials, referrals and the like by establishing predetermined correlation of credits to promotional actions that do not require a contact of the user (eg. another user) to act on the promotional action.

The system may allow for scale-up to accommodate a plurality of sponsors by requiring sponsors to purchase a majority of the credits that are circulating in the system at any given time point. Requiring sponsors to purchase credits sets a standard for a plurality of sponsors to compete for the promoting actions of users and mitigates inflation that may occur if sponsors were permitted to arbitrarily generate credits.

Examples of accumulation and redemption of credits have been described in commonly owned, co-pending International Application No. PCT/CA2013/050723 filed 20 Sep. 2013 published under International Publication Number WO2015/039208 (published 26 Mar. 2015), the entire disclosure of which is incorporated by reference herein.

Referring to the drawings, an example of the system, and method for providing the same, will be described in the context of a user and a sponsor interaction for illustrative purposes. In practice, the system and method can accommodate any number of user-sponsor interactions including one-to-one, one-to-many, many-to-one and many-to-many.

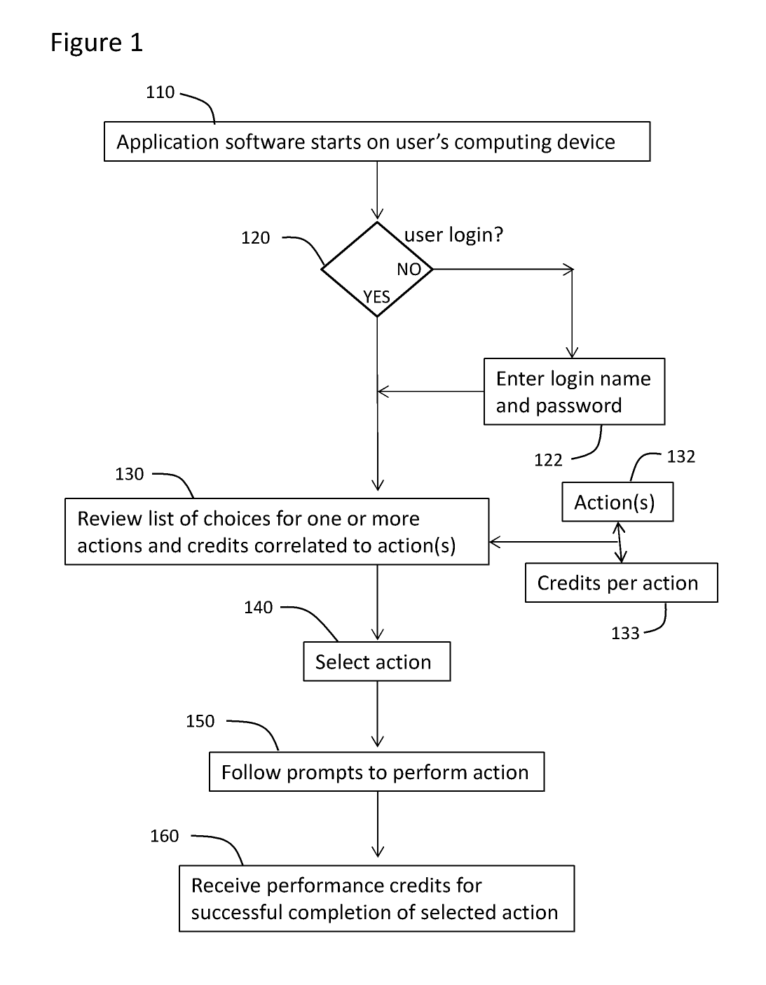

FIG. 1 shows a block diagram describing an example of a user performing a promotional action within the system. The user may perform the steps shown in FIG. 1 using an application installed on a personal computing device or using a website interface for an online application connected to a server computer. For convenience the steps are described in the context of an application installed on the user's personal computing device. Typically, upon start-up of the user's computing device an end-user interface application software previously installed on the computing device will start (110) and initiate a networked communication with a server computer of the system. The server computer will typically require login information (120) that may be provided by the application software in the form of a stored electronic data packet such as an electronic cookie. In the absence of automated login information provided by the application software, the user is prompted to manually enter the login information (122) such as a login name and password. Once in a logged in environment the user can access a list (130), for example as a pull down menu, of promotional action types (132) and correlated credit values (133) predetermined by a sponsor. Alternatively, the system may generate and provide the user with one or more options to perform a promotional action (130) in a context dependent fashion, for example the system may provide a different set of options based on geographical location of a user's personal computing device within a retail outlet of a sponsor versus an Internet search for a sponsor's product. The system generated context dependent options will typically be a subset of a full list of promotional action types (132) and correlated credits (133) predetermined by the sponsor. Moreover, a sophisticated or experienced user may have a prior understanding of the credits scheme set by the sponsor and may not need or desire to access lists or be provided with system generated options to perform promotional actions. Regardless of whether the user understands the options for promotional actions through intentional navigation of the application interface, receiving a system generated list, or prior experience, the user selects a promotional action relevant to the sponsor (140). The system may generate prompts to guide the user to perform the selected action (150). However, sophisticated users may be able to perform the promotional action without using prompts from the application interface.

Promotional actions are any type of actions predetermined by the sponsor as being beneficial to the reputation of the sponsor and include, for example, a purchase, a scan of a product code, a geographical check-in, an image of a product posted on a website, a text testimonial posted on a website, a video testimonial posted on a website, or a video showing use of the product posted on a website. Various alternatives for performing an action may be accommodated by the application software. For example, if the action is to post an image of a sponsor's product on a website then the application software can provide a choice of selecting an image from a gallery of the sponsor's product images stored in memory, allowing the user to take a picture of the product with the user's computing device if it includes a digital camera, or uploading an image of the product captured by the user with a separate digital camera.

After the user completes the action the system validates the action as a promotional action and updates the user's credit balance to add the predetermined credits correlated to the promotional action (160) and also subtracts the credits from the sponsor's credit balance. Furthermore, the transactional history of each credit added to the user's credit balance is updated to register the transfer of the credit to the user (not shown).

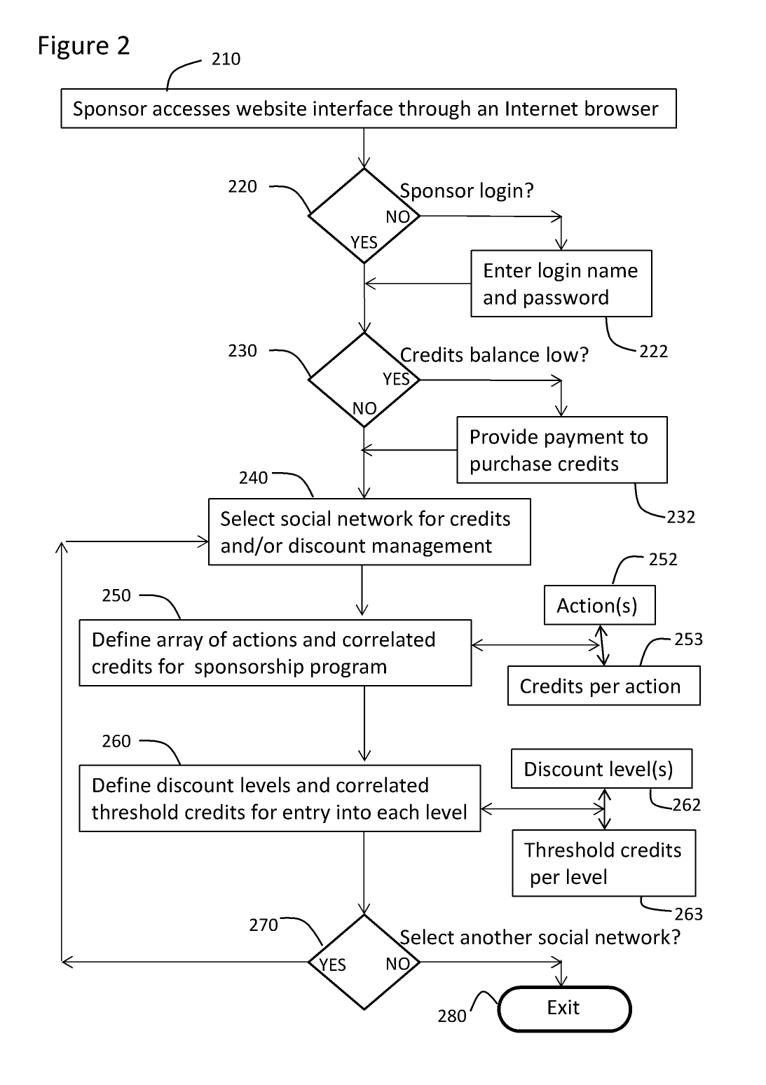

FIG. 2 shows a block diagram describing an example of a sponsor using the system to initially establish criteria for allocating credits to users that perform a promotional action and to establish credit thresholds for a plurality of discount levels for purchase of the sponsor's products. The sponsor may perform the steps shown in FIG. 2 using an application installed on a personal computing device or using a website interface for an online application hosted on a server computer. For convenience the steps are described in the context of the sponsor's interaction with a website interface. Typically, the sponsor uses an Internet browser on the sponsor's computer device to initiate a networked communication with a website interface (210) hosted by a server computer of the system. The server computer will typically require login information (220) that may be provided by the sponsor's computer device in the form of a stored electronic data packet such as an electronic cookie. In the absence of automated login information provided by the sponsor's computer device, the sponsor is prompted to manually enter the login information (222) such as a login name and password. Once in a logged in environment the sponsor may observe the credit balance held in the sponsor's account (230) and if the sponsor considers the credit balance to be low the sponsor may purchase credits (232) to ensure that the sponsor's account remains active. Alternatively, the sponsor's account may have an automatic top up of credits if it reaches a low credit balance limit that the sponsor can select and set. For example, if the sponsor's account credit balance falls below a 200 credit limit predetermined by the sponsor, then an automatic payment is made via a sponsor's stored payment method to top the sponsor's account up to 1000 credits (not shown). The sponsor can then select a social networking website (240) communicative with the system to establish criteria for allocating credits for promotional actions (250) performed by the users of the social networking website and to establish criteria for allowing the users access to a plurality of discount levels to purchase a sponsor's product (260).

To establish credit allocation criteria (250), the system may provide the sponsor with a datagrid check box allowing the sponsor to select promotional actions (252) from a list and to enter a credit value for each selected promotional action (253). Additionally, the sponsor may be permitted to enter a multiple value for each selected promotional action to define the number of times that each selected promotional action may be repeated before ceasing to earn credits according to the correlated credit value (not shown).

To establish criteria for access to discount levels (260), the system may provide the sponsor with a datagrid check box allowing the sponsor to select discount levels (262) from a list and to enter a credit threshold value for each selected discount level (263). Discount levels may be defined according to any conventional discounting scheme including percentage discounts or absolute value discounts on a minimum purchase. Typically, the system will allow the sponsor to select a base discount level that a user may access to purchase the sponsor's product regardless of the credit balance in the user's account. Further discount levels may be selected in a positively correlated tiered fashion with a discount level that provides a greater discount correlated with a greater credit threshold value. For example, a first discount level may be a base discount level correlated with a zero credit threshold value, and a second discount level correlated with a greater than zero credit threshold value will provide a greater discount than the first discount level.

Once the sponsor has established credit allocation and discount level criteria for a social networking website communicative with the system, the sponsor may apply the established criteria to any other social networking website communicative with the system or may execute steps 250 and 260 for each of the other social networking websites (270). The sponsor may define different criteria for each social network as desired. The sponsor can create a template of criteria, copy it over to other networks and then modify the template to set criteria specific for each social network. This provides the sponsor with options to engage the user differently for each social network. Of course, if desired the sponsor may choose to engage them all with the same criteria. Thus, the sponsor is provided the option to tailor engagement strategies specifically for each social network and then for each discount level.

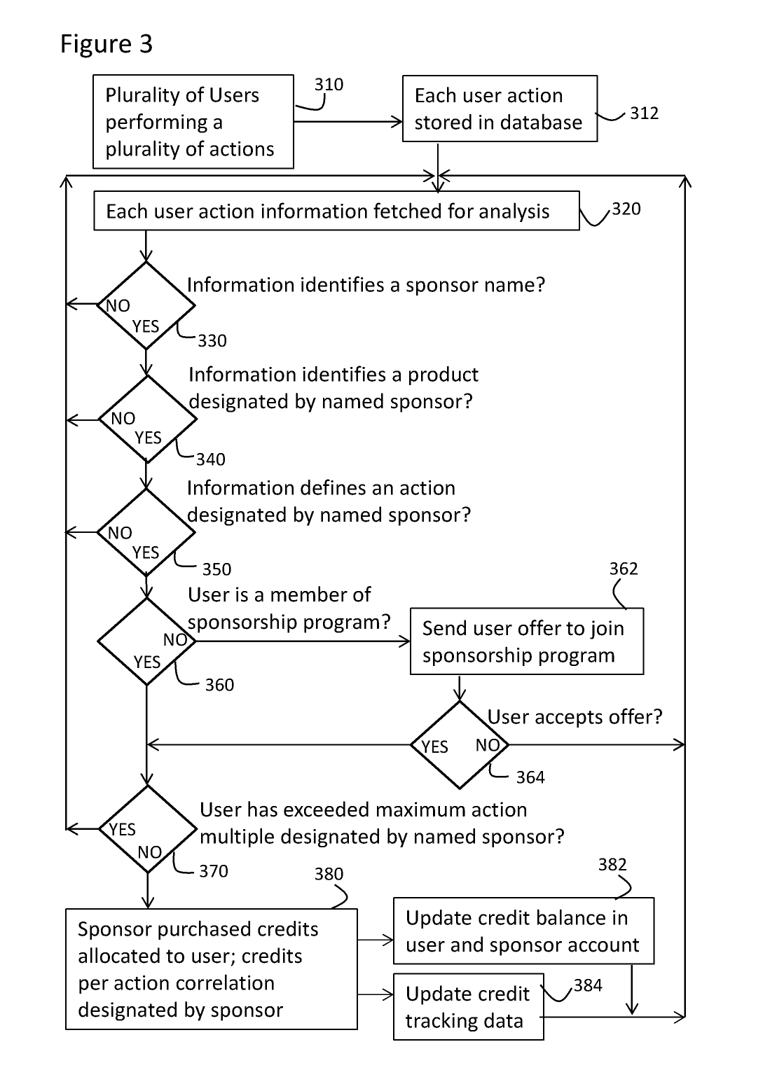

FIG. 3 shows a block diagram describing an example of a monitoring component of the system that monitors user actions and identifies promotional actions within a social networking website communicative with the system. In a social networking website there are many users, each performing a plurality of actions (310). The user actions are stored in a storage system controlled by the social networking website as well as being stored in a mirror storage system that can be accessed by the monitoring component (312). Data transfer to the mirrored storage system may be through a push or pull mechanism depending on the desired implementation. Out of the plurality of user actions, a portion will be promotional actions. Thus, to identify promotional actions each user action may be fetched from the mirror storage system (320) and analyzed or queried for the presence of aspects of a promotional action. A first query may be to assess that the information in the user action contains an identifier relating to a sponsor name or the sponsor name per se (330). A second query may be to assess that the information in the user action contains an identifier relating to a product of the named sponsor name or the name of the product per se (340). Alternatively, the first and/or second queries may be satisfied if a user posts an item directly on the sponsor's web page within a social networking website. Accordingly, a user may receive credits for naming and mentioning the sponsor and/or the product without explicitly stating the sponsor's name or product. A user may receive full naming credits because the action was done within the sponsor's page. The system timeline can register that the user performed an action in the sponsor's page and the system will automatically provide links around that action, mentioning the sponsor's name/page. A third query may be to assess that the information in the user action defines an action with a corresponding credit value designated by the named sponsor (350), for example posting an image of a sponsor's product may correspond to 10 credits. In the example described in FIG. 3, if one or more of the first, second and third queries yields a negative response, then the action is not considered a promotional action and analysis proceeds to the next user action fetched from the mirror storage system. If all three queries are present then the action is considered to be a promotional action and the user is identified (360). If the user is a member of the sponsorship program then the user account is checked for credits received for previous actions (370) having the same three characteristic features, and if the number of such previous actions equals or exceeds an action multiple value predetermined by the sponsor then the user is not provided with further credits and analysis proceeds to the next user action fetched from the mirror storage system. Otherwise, the system validates the action as a promotional action and credits purchased by the named sponsor are transferred to the user (380) by updating the user's credit balance to add the predetermined credits corresponding to the promotional action (382) and also subtract the credits from the sponsor's credit balance. Furthermore, the transactional history of each credit added to the user's credit balance is updated to register the transfer of the credit to the user (384). If the user is not a member of the sponsorship program then the user is presented with an offer to join (362) and upon acceptance of the offer, credits purchased by the named sponsor are transferred to the user according to steps 380, 382, and 384.

If the user exceeds the limit of credit issuance by allowed promotion action then the system will inform them of such and suggest other actions that are available to earn credits within the current sponsorship level of the sponsor. This allows the user to engage further on other activities that the sponsor deems valuable as promotion of the sponsor. Gamification of the credit issuance such as how many more credits does a user need to gain access to the next discount level, or how many days based on the user activity history can be used to encourage user engagement in a sponsor directed fashion.

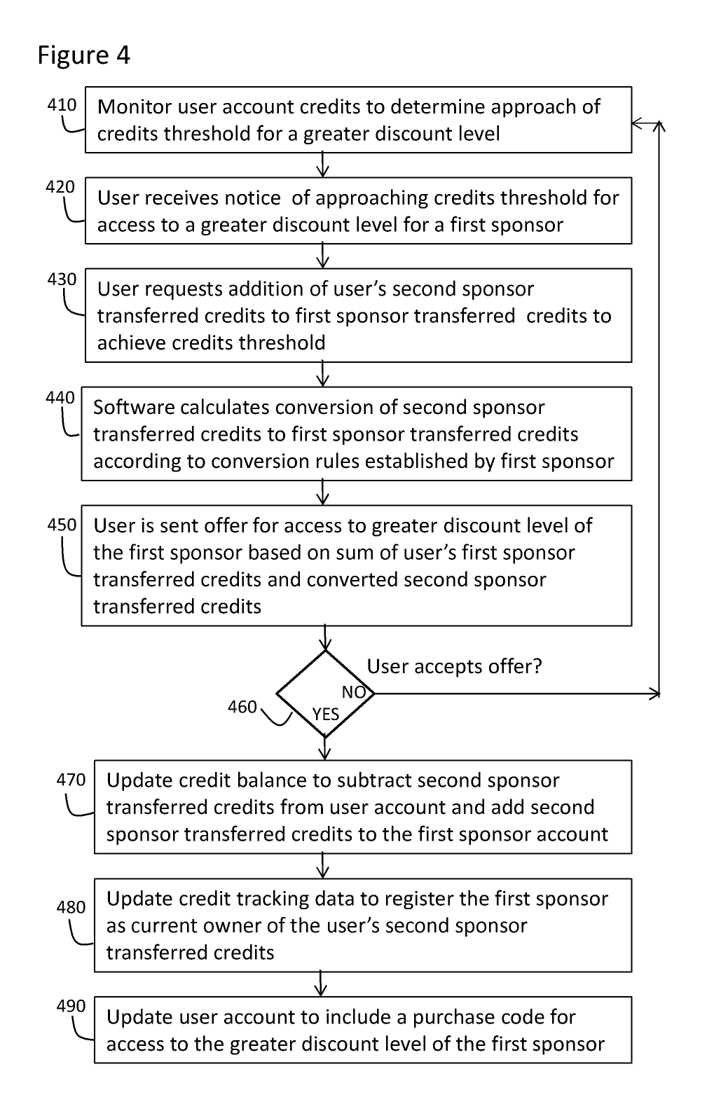

FIG. 4 shows a block diagram describing an example of the system promoting a user from a first discount level of a sponsor to a second discount level of the sponsor, the second discount level providing a greater discount than the first discount level. Since the system will typically comprise a plurality of participating sponsors, a user account may hold sponsor allocated credits from a plurality of participating sponsors. While FIG. 4 describes an example of a user account holding credits allocated from first and second sponsors, it will be recognized that the system can accommodate credits allocated from a greater number of sponsors. The user accounts are monitored to determine credit totals on a sponsor specific basis (410). In this example, the first sponsor allocated credit total is greater than the second sponsor allocated credit total and is closer to the credit threshold established by the first sponsor. The system notifies the user (420) when the user account holdings of the first sponsor allocated credit total approaches a predetermined credit threshold established by the first sponsor for promoting a user from the first discount level to the second discount level. This notification can serve to motivate the user to perform promotional activities relating to the first sponsor to earn credits to achieve the credit threshold. In the absence of earning further credits, the user may be provided an opportunity to purchase credits (not shown). Alternatively, in the absence of earning further first sponsor allocated credits, the notification can allow the user to request conversion of all or part of the user account holdings of the second sponsor allocated credits to make up the difference between the current holdings of the first sponsor allocated credits and the credit threshold (430). The system calculates conversion of the second sponsor allocated credits to first sponsor allocated credits according to predetermined conversion rates established by the first sponsor or an administrator of the system (440). If the sum of the first sponsor allocated credits and the converted second sponsor allocated credits is sufficient to equal the credit threshold then the user is offered access to the second discount level (450). If the user accepts the offer (460) then credit balances of the user's account and the first sponsor's account are updated to reflect transfer of the second sponsor allocated credits from the user's account to the first sponsor's account (470) and to update the transactional history of each credit transferred to the first sponsors account to register the first sponsor as current owner of each of these credits (480). Furthermore, the user's account is updated to include a purchase code that may be graphically represented as a discount coupon or badge for access to the second discount level of the first sponsor and the user retains holdings of the first sponsor allocated credits. It will be recognized that rules for conversion and transfer of credits may vary widely depending upon a desired implementation. For example, a transfer of both first sponsor allocated credits and second sponsor allocated credits may occur in exchange for a discount coupon or badge such that the user holdings would be depleted of the first sponsor allocated credits. In a further example, the transfer of first and second sponsor allocated credits may be transferred to an administrator of the system instead of the first sponsor's account. In still a further example, when a user is promoted to a next sponsorship level a fee may be assessed by the administrator in the form of credits, representing 1-5% of the total credits required to gain access to the next level. These credits can be returned to the administrator's treasury, with the original identifier still retained along with all the transactional history of usage and issuances on such credits. These credits can further be issued to sponsors by selling them to sponsors; consistently charging for credits controls deflation of value of the credits.

Whenever accumulated credits are transferred or redeemed or such transfer/redemption events are proposed such as described in FIG. 4 a valuation of the accumulated credits may facilitate proposal and/or acceptance of the transfer/redemption of credits. A valuation of credits can involve any number of indicators such as economic, behavioural, social, reputational, and the like. A valuation of accumulated credits may be specific to each user, to each sponsor, or to a combination of each user and each sponsor in each proposed transfer/redemption event. A valuation of credits can be useful whenever credits are offered for redemption regardless of whether the credits are being offered to the same or different sponsor that provided the credits to the user. When the offer for redemption is made to the same sponsor that originally transferred the credits to the user, the sponsor may be familiar with certain parameters of the valuation based on a historical familiarity and existing action/reward relationship with the user, but may lack insight into parameters that are outside the action/reward data such as a social impact of the user unrelated to action/reward events. A valuation of credits may be particularly useful when the credits are offered for redemption from a user to one or more sponsors that did not originally transfer the credits to that user, as these one or more sponsors lack the historical familiarity and existing action/reward relationship.

A historical analysis of a user's actions may be considered as a component of the valuation process. Each user action that is rewarded with credits is logged in a database. Optionally, user actions that are not rewarded with credits, such as a repeat action that exceeds a sponsor's maximum multiple limit, may also be logged. Each logged entry will include the type of user action, and an identifier of the sponsor that provided the credits reward. Optionally, other associated parameters can include time, location, social network type, or the specific brand or product. One or more of these parameters may be considered for valuation of a user's credits.

Analysis of transaction history of credits offered for redemption may also be a component of the valuation process. For example, analysis of the transactional history of credits may identify brand or product associations that may influence a sponsors motivation to engage a user offering the credits for redemption. Credit tracking mechanisms will typically involve a log server to register each purchase, allocation, transfer, conversion, redemption and the like to document a history for each credit or each increment or packet of credits as desired. Credit tracking mechanisms may log any number of different data including, for example, a type of user action, sponsor named or identified in a user action, date, time, location, social network platform, and the like.

Analysis of a user's social impact or social influence may also be a component of the valuation process. A basic unit of social impact or social influence is interaction, more specifically interaction of a user with neighboring nodes in a social graph. An interaction may comprise both a user interacting with a neighboring node or conversely the neighboring interacting with the user. Social impact or social influence quantifies these interactions. In this quantification, each basic unit of interaction may be further defined by mathematical considerations of the social graph. For example, a user's direct neighbor node (first order node) may have a different mathematical weighting than a user's second order node (a user's neighbor's neighbor), given that other significant aspects of the interaction remain constant such as when retweeting an identical message. Examples of interaction types include Retweets, Replies, Mentions or Follows on Twitter or Posts, Mentions, Likes, Shares or Event Invitations on Facebook.

Analysis of sponsor-centric parameters such as sponsor-to-sponsor associations, sponsor activity on social networks, sponsor history of credit allocation, or sponsor profile traffic may also be a component of the valuation process.

In any proposed transfer/redemption of credits a sponsor considering the redemption may be able to mine the transactional history of the credits as well as various specific indicators of the user's history or social impact such as engagement, sponsor association, reach or influence, rate of credit accumulation, rate of credit redemption, and the like. However, it will be useful to provide a score or rating that assimilates one or more indicators relating to a user's history or a history of credits offered by a user in a proposed transfer/redemption event. When scores for all users enrolled in the system are on a single scale normalized for all users, the individual score of a user can be quickly and conveniently assessed by its placement within the range of the single scale. Similarly, when scores for all sponsors enrolled in the system are within a single scale normalized for all sponsors, the individual score of a sponsor can be quickly and conveniently assessed by its placement within the range of the single scale. In certain examples, the single scale for users and the single scale for sponsors can be the same scale. Normalizing user scores, sponsor scores or both user scores and sponsor scores to a single scale helps users and sponsors extract quick inferences as to social influence or impact without needing extensive programming resources to mine individual indicators extractable from the credit transaction history or user actions history. Establishing scores improves transparency and/or fairness of the redemption process. Without scores or ratings, sponsors with abundant programming resources may hold an informational advantage in being able to mine the historical data of credit transaction history or user history to yield valuations, while user and sponsors without the programming capacity would lack such information. Accordingly, without scores or ratings, users may undervalue their own credits. With scores or ratings, any proposed offering for credit redemption may be viewed in the context of each proposed offering to a different sponsor yielding a specific valuation, which may provide a convenient basis for a user to compare the different sponsors and different proposed offerings.

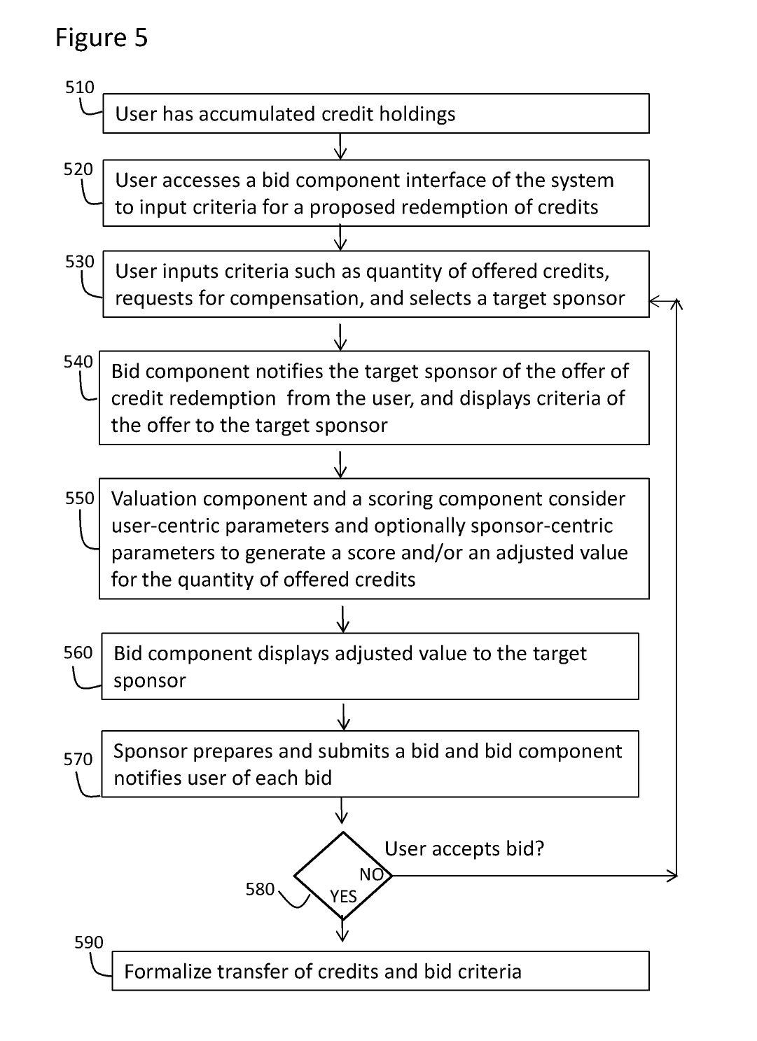

FIG. 5 shows an example of a user offering credits to a single target sponsor. The user may have accumulated credit holdings (510) that are significantly greater than credits needed to move from a first discount level to a second discount level and may wish to conduct a more specialized or customized redemption. The user can access a bid component (520) and enter a proposed quantity of credits for redemption, one or more specific requests for compensation, and an identifier of the single targeted sponsor (530). The bid component proceeds to notify the targeted sponsor of the offer of credit redemption (540) from the user and any requests for compensation the user may have specified. The sponsor may automatically be provided with a valuation of the offered credits in conjunction with the notification. Alternatively, a valuation component may require a sponsor request prior to initiating a valuation analysis of the offered credits by the valuation component. The valuation component upon receiving the request interacts with a scoring component to analyze one or more of user action history, credit transaction history, and user social networking history to generate scores and a valuation of the offered credits (550). Thus, the valuation analysis considers user-centric parameters (550), including for example parameters extracted from one or more of user action history, credit transaction history, and user social networking history. Optionally, the valuation analysis may consider sponsor-centric parameters including, for example, parameters extracted from one or more of credit transaction history, sponsor credit purchase history, sponsor credit allocation history, sponsor social networking history, and sponsor website traffic. The valuation component determines an adjustment of the quantity of offered credits based on the valuation analysis. The adjusted value of the credits can then be displayed to the sponsor (560). The sponsor is provided with the opportunity to compare and consider the quantity of offered credits and the adjusted value of the offered credits to facilitate preparation of a bid for the offered credits (570). Optionally, both the user and the sponsor may independently request valuation of offered credits and both may independently gain access to the valuation analysis and the valuation result. The user is notified of the sponsor bid and is provided an opportunity to accept the bid (580) and proceed to formalize redemption of credits (590), or reject the bid and optionally provide a new quantity of offered credits for bid.

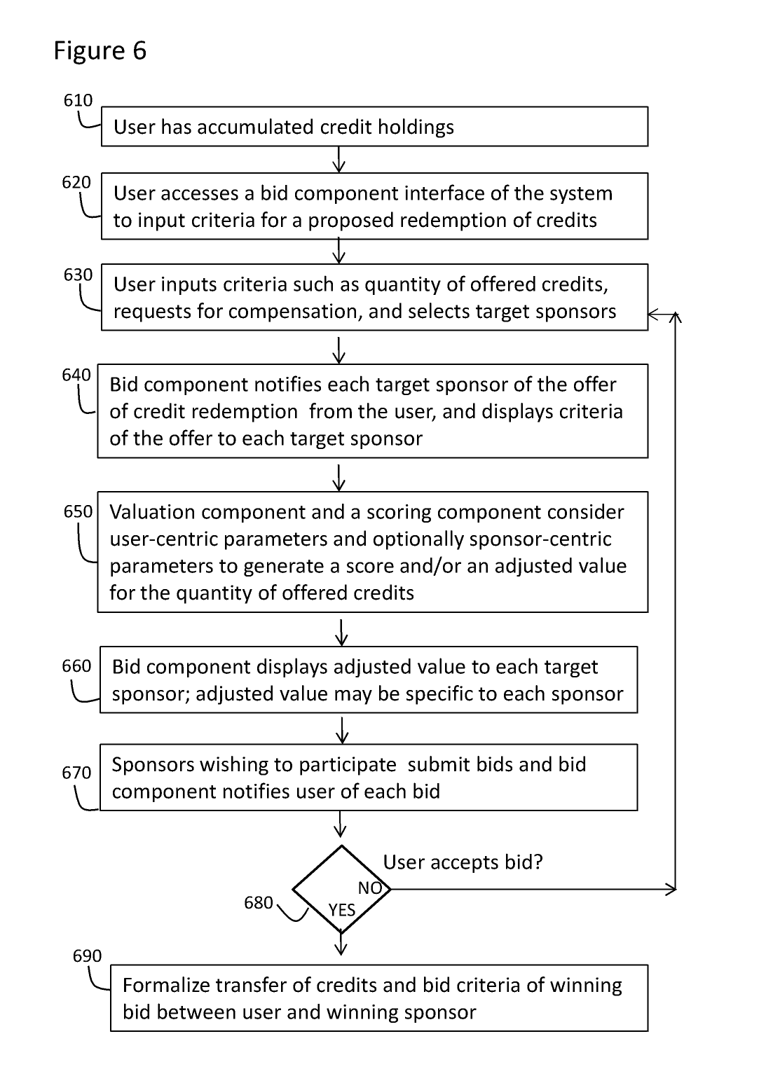

FIG. 6 shows an example of a user offering credits similar to steps shown in FIG. 5, but differing in that a quantity of credits are offered for bid to a plurality of target sponsors. The user may have accumulated credit holdings (610) that are significantly greater than credits needed to move from a first discount level to a second discount level and may wish to conduct a more specialized or customized redemption. The user can access a bid component (620) and enter a proposed quantity of credits for redemption, one or more specific requests for compensation, and an identifier for each of the plurality of targeted sponsors (630). The bid component proceeds to notify (640) each of the plurality of targeted sponsors of the offer of credit redemption from the user and any requests for compensation the user may have specified. The sponsor may automatically be provided with a valuation of the offered credits in conjunction with the notification. Alternatively, a valuation component may require each sponsor to make a request prior to initiating a valuation analysis of the offered credits by the valuation component. The valuation component upon receiving the request interacts with a scoring component to analyze one or more of user action history, credit transaction history, and user social networking history to generate scores and a valuation of the offered credits (650). Thus, the valuation analysis considers user-centric parameters, including for example parameters extracted from one or more of user action history, credit transaction history, and user social networking history. Optionally, the valuation analysis may consider sponsor-centric parameters including, for example, parameters extracted from one or more of credit transaction history, sponsor credit purchase history, sponsor credit allocation history, sponsor social networking history, and sponsor website traffic. The valuation component determines an adjustment of the quantity of offered credits based on the valuation analysis. The adjusted value of the credits can then be displayed to each sponsor that requested a valuation (660). Each sponsor is provided with the opportunity to compare and consider the quantity of offered credits and the adjusted value of the offered credits to facilitate preparation of a bid for the offered credits (670). Optionally, both the user and one or more of the sponsors may independently request valuation of offered credits and both may independently gain access to the valuation analysis and the valuation result. The user is notified of all sponsor bids and is provided an opportunity to select a winning bid and accept the bid (680) and proceed to formalize redemption of credits (690) with the sponsor of the winning bid, or reject the bids and optionally provide a new quantity of offered credits for bid. When a plurality of sponsors are involved in a bidding process, any conventional auction function may be incorporated as desired or suited including, for example, a reserve function.

The valuation analysis of credits may consider user-centric parameters, sponsor-centric parameters or both user-centric parameters and sponsor-centric parameters. Consideration of both user-centric and sponsor-centric parameters may be particularly useful when user credits are offered for bid to a plurality of targeted sponsors, as the valuation analysis and resultant valuation may be specific for each potential user-sponsor pairing.

The valuation may be presented in any number of formats including, for example, an adjusted absolute quantity of offered credits, a multiple for adjusting the quantity of offered credits, a percentage for adjusting the quantity of offered credits, a differential for adjusting the quantity of offered credits. The valuation component and the scoring component can be used to determine whether the value of a quantity of offered credits to the bid component are greater than, less than or equal to a reference value established by a treasury component or credit bank of the system. The reference value established by the treasury component may be a par value, an issuance value, a buyback value or any other consistent manner of determining a reference value of credits in circulation. However, in many instances knowledge of the reference value established by the treasury component may not be critical to a bid proposal or consideration, as relevant information is provided by comparing the adjusted value of offered credits to the original quantity of offered credits and determining a direction (ie., positive or negative) and a magnitude of the adjustment formatted for example as an absolute value, a multiple, a percentage, a differential, and the like.

Several illustrative examples of consideration of user-centric parameters and/or sponsor-centric parameters to generate scores now follow. In these examples the terms “sponsor” and “brand” are used interchangeably. Also, in the following examples the sponsorship management system is abbreviated as SPO.

The following is a sample list of user-centric parameters that may be generated and considered in a valuation analysis
a) User_Social_Capital: The final score given to each user in [300-800] range. This range can be modified as desired.
b) User_Score_SN: The score assigned to each user on each social network (SN) or vertical social network (VSN) in [300-800] range. This range can be modified as desired.
c) User_Score_for_Brand: The score assigned to each user for each brand. It is an unbounded positive numeric value.
d) User_Score_for_Brand_of SN: The score assigned to each user for each brand on each SN. It is an unbounded positive numeric value.
e) Influence_Factor_of SN: The relative portion of user's activities on each SN that he/she has connected to their sponsorship management system account.
f) User_Social_Neutral_Score_of SN: The network value of each user based on its impact on the social network. This parameter is used to determine influential nodes on a SN.
g) User_Social_Activity_SN: measurement of each user's activities on a SN and the reflection (reaction) of his/her activities by other users.
h) Min_Influence_Factor_of SN: The minimum value assigned to each SN. It would be deducted from user score for not connecting a SN to his/her sponsorship management system account.
i) Network_Centric_Factor: The weight of network value for each user toward the final score.

The benefit of a scoring component is to evaluate and quantify the value or overall ranking/status of each user within the system. The assigned value to each user called User_Social_Capital can reflect social influence or impact. Sponsors may elect to categorize users in different classes based on their User_Social_Capital and appreciate various classes differently in terms of providing discounts or promotions. The score of users on each SN (social network) can be decomposed into two parameters; the first, ‘centrality’, indicates the network value of individuals and the influence each node has on the whole social graph (social graph is the abstraction of users and their connection on a social network; a user is called node and the connection is called link) associated with that particular SN. Highly influential nodes on social graph are assigned higher scores. Centrality measures are well studied concepts in SNA (social network analysis; use of network theory to analyze social networks; social network analysis views social relationships in terms of network theory, consisting of nodes and links). The second term is related to implicit activities of each user during a campaign and the reflection of his/her activities on the network through interaction with neighbor nodes. The final User_Score_SN is calculated using

User_Score_SN=μUser_Social_Neutral_SN+User_Social_Activity_SN

Where μ is Network_Centric_Factor parameter and is set to 0.25 in this illustrative example.

User_Social_Capital is the final score calculated and presented to each user on his/her sponsorship management account in the range of [300-800]. Users are classified in different tiers based on this score. This score also determines the discount levels of users when the brands want to release and distribute coupons or promotions. It is calculated through weighted sum of User_Score_SN over all connected social networks. The scalar coefficient factors are SN_Influence_Score:

User_Social_Capital=Σ_{SN}SN_Influence_Score×User_Score_SN

User_Score_SN

User_Score_SN is the assigned value to each user on a SN, based on his/her network value and dynamic of his/her activities on different campaigns for that particular SN. It is a bounded value in the range of [300-800]. User_Score_SN is calculated using

User_Score_SN=μUser_Social_Neutral_SN+User_Social_Activity_SN

Where μ is Network_Centric_Factor parameter and is set to 0.25 for this example.

User_Social_Neutral_SN

This parameter measures the intrinsic network value associated to each node on social graph. It is a scalar value in [300-800]. It shows the influence one node has on the network through interaction with its neighbor nodes and explicit interaction with second-order and other higher-order neighbors. Highly influential nodes on social graph are assigned higher scores. This doesn't necessarily correspond to number of neighbors one node has on social graph. A node with more high influence neighbors has a higher User_Social_Neutral_SN than a node with lots of neighbors with small influence. This can reflect how close a node is to all other nodes on the social graph or how accessible other nodes are through this particular node.

User_Social_Activity_SN Sample List of Parameters
a) User_Activity_Score_SN: indicates the score of a user based on dynamic of his/her social activities during different campaigns.
b) Scalar_of_Social_Marketability the effect of market penetration for each particular SN.
c) User_Self_Score_SN The immediate score each user gets based on his direct engagement on a campaign.

Scoring component calculates User_Social_Activity_SN using following formula.

User_Social_Activity_SN=Scalar_of_Social_Marketability×User_Activity_Score_SN

The two parameters on the right hand side (RHS) of the above formula are explained in the following paragraphs.

Scalar_of_Social_Marketability

This parameter shows the effectiveness of social campaigns on various markets. It is a scalar number in [0-1]. The more direct engagements and participations each SN could generate for that particular market, the higher this parameter would be. Some markets are more reluctant in responding to social marketing and hence have smaller values for this parameter. Values for this parameter for each desired markets can be stored in a database to access this parameter easily and quickly since it doesn't have to be calculated for each user individually.

User_Activity_Score_SN

User_Activity_Score_SN illustrates the value added to network by social engagement and participation of users during each campaign. This value comes from a node's direct activities and also through the reflection of those activities through first order and higher order friends of that node on the social graph. It is calculated using

User_Activity_Score_SN=a₀×User_Self_Score_SN+a₁λavg(User_Self_Score_SN)+a₂×avg(User_Self_Score_SN)+err

to keep estimation error small, err≦1%. The second term on RHS with coefficient a₁ is calculated for all friends of a node on the social graph and the third term is calculated for all second order nodes (friends of friend) for each node.

User_Self_Score_SN

User_Self_Score_SN is the average of User_Score_Brand_SN over all connected brands for each user.

User_Self_Score_SN=avg(User_Score_Brand_SN) For all brandsεFollowed_Brand_Set

The user's engagement level for each brand on each SN is determined by User_Score_Brand_SN The idea behind smoothing the score by averaging over all connected brands is to incentivize users to increase their engagement level on all connected brands. Users are trained to be more socially active for their favorite brands and hence to make them more socially responsive citizens within a social economy supported by the sponsorship management system. Also, guidance can be provided to a social network to conform to a graph with more and more fat nodes indicating more influential people on social graph.

User_Score_Brand_SN

User_Score_Brand_SN determines the level of activities of each user for one particular sponsor on each SN. It is an unbounded numeric value. It is updated by the score obtained by a user during a campaign.

User_Score_Brand_SN=User_Score_Brand_SN+User_Score_Campaign_SN)

There are two paradigms in updating User_Score_Brand_SN over the lifespan of a social campaign.

1. Partial Updating

In this paradigm, an update happens on the scale of every few hours or at the end of each day. In this approach, users are able to see the changes in their scores very quickly. There are a few problems with instantaneous updates. The first one is the high cost of computation and network traffic generated by each update. In addition, it takes a while for each single activity to reach out other nodes and produce its full potential on the social network. In other words, it takes time for one's messages to generate actions, such as retweets, mentions, likes and comments.

2. Complete Updating

In this paradigm, all the activities during a campaign are considered together in updating the result. The user score doesn't change until the end of a campaign. The sponsorship management system monitors and captures all the activities performed by a user during the course of a campaign. This is suitable for short campaigns that run for one or a few days. For very long campaigns like Olympics that run for couple of weeks, the first paradigm is the more appropriate one.

User_Score_Campaign_SN

User_Score_Campaign_SN is the Transformation Score (in statistics, T-score or Transformation Score is the mapping of a score to a population with different mean and variance but same standard score) of User_Value_Campaign_SN, the value generated by activities of user during a campaign. By normalizing the value generated by a user during a campaign to the whole population on that campaign, the User_Score_Campaign_SN gives a fair and meaningful picture of user participation. If a campaign has derived lots of engagements, a user should try harder to increase his/her score. This also helps in directing attention to less popular campaigns. Each campaign has a limited capacity of engagements and participations. The aggregate value added to each social media during a campaign can't increase unboundedly. For each activity type available for the campaign, users are not allowed to repeat that activity type more than a preset specific number or higher than a preset frequency.

User_T_Score

User_T_Score is the transformation of User_Z_Score under an affine transformation (in geometry, an affine transformation or affine map is a function between affine spaces which preserves points, straight lines and planes. Also, sets of parallel lines remain parallel after an affine transformation) in such a way that the population has mean and variance equal to the pre-specified values determined by a brand manager. The parameters for the mapping are Target_Mean and Target_STD represented by t_μ and t_σ. These two parameters are considered as input to the system and give more control to brand managers over distributing assigned credits. The formula to calculate User_T_Score is as following:

User_T_Score=t_{μ}+User_Z_Score×t_σ

User_Z_Score

User_Z_Score is Standard Score (standard score is the number of standard deviation that one outcome of a random variable is away from its mean) of User_Value_Campaign_SN and is calculated using the following formula:

$$User\_Z \_Score = \frac{User\_Value \_Campaign \_SN - μ}{σ}$$

Where

μ=sample mean(User_Value_Campaign_SN) σ=std(User_Value_Campaign_SN)

are sample mean (sample mean is the arithmetic average of samples taken from a population uniformly) and sample standard deviation of the User_Value_Campaign_SN for the active users on the campaign, respectively.

User_Value_Campaign_SN

User_Value_Campaign_SN is the value generated by user's activities during a certain social media campaign. It is basically the summation of the value of all activities:

User_Value_Campaign_SN=Σ_{all activities}Activity_Value

The summation is based on all types of activity that are provided for that particular campaign. Each activity has a default value that depends on the type of activity. But different activities from the same type might end up getting different attention and engagement on the network. We scale each activity by the amount of engagement it produces on the social graph and set the value for that particular activity to be the default value scaled by the Viral_Factor_Activity. The accumulation of the all the values of individual activities yields the raw score obtained on each SN during that campaign.

### Example 1

Let's consider that at closing of a campaign for brand XYZ, user has performed 7 activities of 3 different types: 3 Facebook (FB) status, 3 Instagram posts and 1 FB video. After calculating Viral_Factor_Activity for each single activity and scaling their default values by the computed factors, the Activity_Value's are as follow:

[2.3, 6.1, 2.7, 8.1, 3.5, 3.7, 5.7]

So

User_Value_Campaign_SN for Instagram is 8.1+3.5+3.7=14.3

And the corresponding value for FB is 2.3+6.1+2.7+5.7=16.8

### Example 2

If for campaign A, user performs 3 posts, 5 images and one video on Facebook (FB) and 2 tweets on Twitter, then the score for the user is:

User_Campaign_SN for FB=3×1.5+5×2.5+15=4.5+12.5+5=22

User_Campaign_SN for Twitter=2×2.2=4.4

Activity_Value

Activity_Value is the value added to the network by a single activity during each campaign. There are two parameters involved in determining Activity_Value. The Default_Value_Activity which depends on the type of activity and is calculated and stored in database before running each campaign. Viral_Factor_Activity serves as an inflation factor that captures the influence made by this single activity on the network. The following formula is used to calculate Activity_Value

Activity_Value=Viral_Factor_Activity×Default_Value_Activity

Viral_Factor_Activity

Viral_Factor_Activity indicates the gain each individual activity can get from network through engagement and participation encouraged by that activity. This gain is realized through interaction of each node with other nodes. The default value for this factor is 1 and it changes according to the following formula:

Viral_Factor_Activity=1+αr+βr²

Where α is First_Order_Avalanche_Coefficient, β is Second_Order_Avalanche_Coefficient and r is Propagation_Coefficient.

First_Order_Avalanche

First_Order_Avalanche is a number of engagements a user activity produces through the user's friends (first order nodes) during a campaign. For one particular event, it is simply the number of contents published on that particular SN which is caused by that event. If the user's friends share one video the user posted for a campaign 15 times, the First_Order_Avalanche for that action is equal to 15.

Second_Order_Avalanche

Second_Order_Avalanche is the number of engagement produced by a single activity through second degree friends (friends of friends; second order nodes) on a social network. A trace for each single activity can be tracked and stored on a database. The content being published is not of primary interest, but the path it takes to get published on that campaign is a primary concern. If for example one particular video is published by two users on the same campaign at different times, they are both considered as original content and do not count in avalanche.

### Example 3

For each event, IDs for the original publisher and the references to the previous users, if there are any, are trached and stored. Credit is given to the original poster right away and the reference's first order and second order avalanches lists are updated. In this example, only two levels of references, ref1 and ref2, are tracked and stored.

| User ID | Event ID | Content | Time | Ref1 | Ref2 |
|---|---|---|---|---|---|
| 2079477183 | 9037860200 | | 17:23:10, | 3733821900 | NA |
| | | | 2014-08-05 | | |

So the record for the User 3733821900 is updated:

| | | | First Order | Second Order |
|---|---|---|---|---|
| User ID | Event ID | Time | Avalanche | Avalanche |
| 3733821900 | 9037860200 | 17:23:10, | 1 | 0 |
| | | 2014-08-05 | | |

First_Order_Avalanche_Coefficient

First_Order_Avalanche_Coefficient (α) is the propagation factor for a single activity of a user on the social graph through his/her first order friends (direct neighbor nodes; second order nodes). It is a reflective factor for each social activity which determines the first layer engagement on a social graph.

$$α = \frac{{α}_{1}^{2}}{1 + {α}_{0}^{2} + {α}_{1}^{2} + {α}_{2}^{2}} \times \frac{1}{10} \times First\_Order \_Avalanche$$

Second_Order_Avalanche_Coefficient

Second_Order_Avalanche_Coefficient (β) is the propagation factor for a single activity of a user on the social graph through his/her second order friends (second order nodes). It is a reflective factor for each social activity which determines the second layer engagement on a social graph.

$$β = \frac{{α}_{2}^{2}}{1 + {α}_{0}^{2} + {α}_{1}^{2} + {α}_{2}^{2}} \times \frac{1}{10} \times Second\_Order \_Avalanche$$

Propagation_Coefficient

Propagation_Coefficient (r) is the adjusting deflation factor in calculating accumulating value of a single activity. This parameter captures attenuation effect of each single activity by increasing the distance from the publisher node. It is a numeric value in [0, 0.5). It imposes an upper bound on Viral_Factor_Activity terms and prevents each single activity's payoff to get larger unboundedly.

$$Viral\_Factor \_Activity = 1 + α r + β {r}^{2} \leq 1 + r + {r}^{2} < {\sum }_{n = 0}^{∞} {r}^{n} = \frac{1}{1 - r}$$

$$And$$

$$\frac{1}{1 - r} \leq 2$$

$$for$$

$$r ∈ [ 0 , 0.5 )$$

So the upper bound for this parameter is 2.

### Example 4

Consider a single activity with the following parameters:

r=0.3, α₀=1, α₁=10⁻¹, α₂=10⁻³

So α=10⁻³×2000=2 and β=0.2

Therefore 1+rα+βr²=1.618

So the viral factor for this activity for r=0.3 is 1.618. If the default value for the activity 1.7, then the

Activity_Value=1.618×1.7=2.75

| | | Viral_Fac- | |
|---|---|---|---|
| Activity_Type | Default_Value | tor_Activity | Activity_Value |
| Video | 2.1 | 1.2 | 2.52 |
| Video | 2.1 | 1.9 | 3.99 |
| Video | 2.1 | 1 | 2.1 |
| Video | 2.1 | 2.3 | 4.82 |
| Text | 1.1 | 3.7 | 4.07 |
| Text | 1.1 | 1.5 | 1.65 |

So at the end of the campaign:

User_Value_Campaign_SN=19.15

SN_Influence_Score Sample List of Parameters:
a) SN_Influence_Score: The portion of contribution of each SN towards user's final score.
b) SN_Influence_Ratio: The ratio of value of activities on each SN to all the value generated on all SN's.
c) Min_Influence_SN: The minimum penalty of not connecting one SN to a sponsorship management system account.
d) Min_Influence_Sum: The summation of Min_Influence_SN for all the SN's not connected to the sponsorship management system account.
e) SN_Influence_Th1: Threshold for Min_Influence_Sum
f) SN_Influence_Th2: Threshold for SN_Influence_Score

SN_Influence_Score determines the relative portion of all the value added to each SN by performing various activities to the total value over all SNs. In the following ratio:

$$SN\_Influence \_Ratio = \frac{Σ Activity\_Value}{{\sum }_{SN such tha user ∈ SN} \sum Activity\_Value}$$

the numerator is the value of all different activities on the desired SN and the denominator is the summation of these values on all social networks which the user has connected to the sponsorship management system. If this ratio is greater than a minimum value called SN_Influence_Th1, a penalty is applied to the user score for not connecting some SN to a sponsorship management account. The depreciation term is the summation of Min_Influence_SN assigned to each SN. A saturation function may be applied to Min_Influence_Sum to clip the values greater than SN_Influence_Th2, which is set to, for example, 0.2. Hence the highest adjustment made to SN_Influence_Score is (1−SN_Influence_Th2).

Min_Influence_Sum=T₁(Σ_{userεSN}Min_Influence_SN)

Therefore the contribution of each SN on the final user's score is

SN_Influence_Score=T₂(SN_Influence_Ratio)

Where T₂ doesn't change the input value if it is less than SN_Influence_Th2 and scales down it by (1−Min_Influence_Sum) when it is greater than SN_Influence_Th2.

Min_Influence_SN

Min_Influence_SN indicates the minimum contribution of each SN to the overall user score. Since SN_Influence_Ratio is normalized to only those already connected SN, this term penalizes users for not connecting some of the available SNs. It would generate slight motivation for users to connect as many SN as possible to their accounts while not penalizing them by a large value. A super active user on FB and Twitter may be more valuable to a social ecosystem than a user moderately active on all available SNs.

### Example 5

Let's say the aggregate value of activities on FB is 700K, on Twitter 500K and on Google+ is 300K. A user has obtained User_Score_SN of 70 and 60 on FB and Twitter, respectively and those are the only SN connected to the sponsorship management system account. For the sake of simplicity, 0.05 is assigned as Min_Influence_Score for all three SNs.

$$FB \text{:} SN\_Influence \_Ratio = \frac{700 K}{700 K + 500 K} = 0.583$$

SN_Influence_Score=0.583×(1−0.05)=0.554

$$Twitter \text{:} SN\_Influence \_Ratio = \frac{500 K}{700 K + 500 K} = 0.417$$

SN_Influence_Ratio=0.417×(1−0.05)=0.396

User_Social_Capital=0.554×70+0.396×60=62.54

But the user's potential score would be

0.583×70+0.417×60=65.83

These 3 scores lost are due to not connecting Google+ to the sponsorship management system account.

User_Score_Brand Sample List of Parameters
a) User_Score_Brand: The projection of user's score to a specific brand.
b) User_Score_Brand_SN: The projection of user's score to a specific brand and a specific SN

User_Score_Brand is the score of user for each brand he/she is following or promoting. It is a positive numeric value which can increase unboundedly. The more this score is, the more valuable this user is for the brand and can get higher levels of discounts and coupon. Brands can target different user segments based on this score.

User_Score_Brand=Σ_{SN}SN_Influence_Score×User_Score_Brand_SN

User_Score_Brand_SN

User_Score_Brand_SN is the projection of user's score to a specific brand and specific SN. This parameter is computed by summation of User_Campaign_SN for all the campaign tags in the Joined_Campaign_Set of a particular brand.

User_Score_Brand_SN=Σ_{campaign in join}_{_}_{Campaign}_{_}_{Set}User_Campaign_SN

Brands Metric Sample List of Parameters

The following is a sample list of sponsor-centric parameters that may be generated and considered in a valuation analysis
a) Brand_Score: The final score given to each brand in the range of [0-100]. This range may be modified as desired.
b) Social_Activity_Factor: Portion of Brand_Score that captures the ongoing campaign-to-campaign social engagement. It is in the range of [0-75]. This range may be modified as desired.
c) Market_Type_Factor: The average of social marketability of certain markets which comes from overall social engagements due to all brands on various social networks.
d) Brand_Base_Image: The initial score given to each brand when they join the sponsorship management system for the first time.

Consideration of sponsor-centric parameters allows comparison of sponsors with a [0-100] scoring system to quantify social engagements of sponsors. The scoring scheme is based on the following simple looking formula:

Brand_Score=Brand_Base_Image+Social_Activity_Factor

Brand_Base_Image constitutes a small portion of the overall score and is calculated only once when a brand starts using sponsorship management system (SPO) services. Social_Activity_Factor is the major constituting part of the overall score and it is the main focus of SPO analytics engine. The following paragraphs discuss how to calculate each component of the right hand side (RHS) separately. Brand_Base_Image is similar to new to market IPO share pricing, the market determines the initial price for trading the shares based on internal scaling of the market and market internal evaluation. For SPO model, Brand_Base_Image serves as an initial static score and Social_Activity_Factor captures the dynamic behavior in Brand_Score.

Updating Brand_Score

For each campaign, one score is calculated in the range of [0-75] based on the engagement and participation level it could bring to the brand. Then the Social_Activity_Factor is updated and set to be the simple moving average (a simple moving average (SMA) is the unweighted mean of the previous n data) of all campaign scores from the beginning. For a brand to get higher score, it needs to run a couple of successful campaigns in a row in order to increase its final score. Conversely, the impact of one failed campaign alone may not significantly decrease a score due to smoothing provided by SMA. Social_Activity_Score after closing n^{th} campaign is:

$$New\_Social \_Activit \_Score = \frac{\begin{matrix}( n - 1 ) \times Current\_Social \_Activit \_Score + \\ the score of {n}^{th} campaign\end{matrix}}{n}$$

### Example 6

Consider that brand XYZ has carried on 5 campaigns so far and the brand manager is thinking of planning the sixth campaign. The Brand_Base_Image for this company is 20 out of 25, which is calculated based on the brand's overall strength and value. The scores for previous five campaigns are: [15, 30, 50, 50, 65] where 0 is lowest possible and 75 is maximum score based on full scale social sponsorship management system. After evaluating the most recent one (the sixth one), SPO engine gives a score of 35 to the campaign. The Brand_Base_Image is still unchanged and equal to 20. The current score for the brand is:

$$current score = 20 + \frac{15 + 30 + 50 + 50 + 65}{5} = 62$$

And the new score is

$$new score = 20 + \frac{5 \times ( 62 - 20 ) + 35}{6} = 60.83$$

Although the performance of the most recent campaign was poor, because they had some pretty strong previous campaigns, the drop in the score is minimal.

Social_Activity_Factor sample list of parameters
a) SN: available social networks with SPO. There are five of them in this example: Facebook, Twitter, Google+, Instagram and Youtube
b) VSN: Vertical Social Networks which are created social channels within existing social networks around influential entities on the networks. For example, the graph associated to each celebrity or influencer can be recognized as one VSN.
c) Score_Matrix: These matrices represent assigned values to different actions and activities based on the tiers of the users that have done those social activities.
d) Num_SN: number of all horizontal social networks recognized by SPO such as facebook, twitter and etc. It has been set to 5 for this example.
e) Num_Market: number of markets that each brand can belong to. It has been set to 50 for the current example.
f) Num_Action: number of possible social activity types such as facebook post, tweets on twitter, like, share and etc. They can be categorized in 5 main classes: text, image, video, like and share.
g) Num_Tier: number of tiers to classify users and rank them based on their engagement levels.

Social_Activity_Factor captures the participation and engagement of brands on different social networks. It is the dynamic part of the overall score and this parameter is in the range of [0-75]. Brands should encourage more engagement and participation among their followers if they want to receive higher scores. Social_Activity_Factor is set to be the weighted sum of Brand_VSN_Factor for all the SN's that brand has connected to its SPO account. Social_Activity_Factor for each brand is then calculated using following formula:

Social_Activity_Factor=Σ_{SN}SN_Influence_Score×Brand_VSN_Factor

SN_Influence_Score

This parameter determines the relative portion of all the value added to each SN by performing various activities to the total value over all SNs.

$$SN\_Influence \_Ratio = \frac{{\sum }_{Activity \_ SN \times Value \_ Activity}}{{\sum }_{SN such tha brand ∈ SN} {\sum }_{Activity \_ SN \times Value \_ Activity}}$$

The numerator is the value of all different activities on the desired SN and the denominator is the summation of these values on all social networks which the brand has connected to SPO. If this ratio is greater than SN_Influence-Th (0.5 for example), a penalty could be applied to the brand score for not connecting sufficient SN to its account on SPO. The depreciation term is the summation of Min_Influence_SN assigned to each SN. A saturation function can be applied to Min_Influence_Sum to clip the values greater than 0.2, so the worst adjustment made to SN_Influence_Score is 0.8.

Min_Influence_Sum=Σ_{brandεSN}Min_Influence_SN

SN_Influence_Score=SN_Influence_Ratio×(1−Min_Influence_Sum)

Min_Influence_SN

This parameter indicates the minimum contribution of each SN to the overall brand score. Since SN_Influence_Ratio is normalized to only those already connected SN, this term penalizes brands for not connecting some of the SNs. It would generate slight motivation for brands to connect as many SN as possible to their SPO accounts while not penalizing them by a large value.

### Example 7

In this example, the aggregate value of activities on FB is 700K, on Twitter 500K and on Google+ is 300K. A campaign run by a brand has obtained Brand_VSN_Factor of 70 and 60 on FB and Twitter, respectively and those are the only SN provided by the campaign. For the sake of simplicity, 0.05 is assigned as Min_Influence_Score for all three SNs.

$$FB \text{:} SN\_Influence \_Ratio = \frac{700 K}{700 K + 500 K} = 0.583$$

SN_Influence_Score=0.583×(1−0.05)=0.554

$$Twitter \text{:} SN\_Influence \_Ratio = \frac{500 K}{700 K + 500 K} = 0.417$$

SN_Influence_Score=0.417)×(1−0.05)=0.396

Social_Activity_Factor=0.554×70+0.396×60=62.54

But the potential score is

Social_Activity_Factor=0.583×70+0.417×60=65.83

This 3 score lost is due to lack of activities on Google+ for that particular campaign.

Score_Matrix

For each (SN, Brand) pair a Score_Matrix is defined that contains the weights assigned to various actions available on the given SN for users coming from different tiers. Rows represent list of available actions on the specified SN. Columns represent different user influence levels (tiers). Each table has five rows and five columns corresponding to five actions and five tires. The entries are scalar values in (0-1) range.

Initialization

We initialize all the matrices entries with equally distributed values and then run simulations based on the randomly generated activities or data gathered from web to update the entries.

### Example 8

### Example of Score_Matrix

The following could be one example of Score_Matrix associated to (FB, Nike) pair:

| | Tier 1 | Tier 2 | Tier 3 | Tier 4 | Tier 5 |
|---|---|---|---|---|---|
| Text | 0.05 | 0.05 | 0.05 | 0.1 | 0.1 |
| Image | 0.1 | 0.2 | 0.2 | 0.3 | 0.5 |
| Video | 0.2 | 0.2 | 0.5 | 0.7 | 0.95 |
| Like | 0.0025 | 0.0025 | 0.0025 | 0.05 | 0.05 |
| Share | 0.1 | 0.1 | 0.1 | 0.15 | 0.25 |

In the above table, we have a vector like:

[FB, Nike, Texting, Tier5]=0.1

It shows that if a user from tier 5 performs one texting activity on Facebook for Nike, the gain he would earn toward his/her total score is 0.1. Looking at another entry from third row and first column we can identify the following vector:

[FB, Nike, Video, Tier1]=0.2

Which means that Nike appreciates posting a video on Facebook, even from a Tier 1 user, more than a texting activity (eg., status) on Facebook from a highly influential user (Tier 5).

The Score_Matrix for the same brand on another SN like Twitter might be totally different from the above table.

Market_Type_Factor Sample List of Parameters
a) Market_VSN_Pattern: The effectiveness of different social networks for various markets.
b) Brand_VSN_Factor: The potential assigned to each brand for each social network.

c) Market_Strength: The distribution of a brand's business over all the markets.

The effectiveness of social sponsorship for a particular product or service on different types of market or business is captured by Market_Type_Factor.

Market_VSN_Pattern

Market_VSN_Pattern demonstrates the distribution of social activities associated to each market on various social networks. It is represented as a Num_Market×Num_SVN matrix. This is a collective parameter, which is assigned to pairs of (Market, VSN) and not each individual brand. Different products have different social marketing potential. For a particular brand with various product lines, one particular market might be much more effective to reach out customers for one given product or service. Practices and methods from portfolio optimization may be used to design efficient social sponsorship strategies for each brand. This parameter may be updated at a desired frequency, for example after each campaign or quarterly or at least annually. Some markets are much more responsive towards certain contents which make a few networks more important. They don't appreciate all social networks equally. For example, for products which visual contents are crucial to influence customers, Instagram is a better approach for social marketing compared to Twitter.

Initialization

For each market type, the relative number of followers on a particular SN compared to number of active users on all social networks for that specific market can be determined. A parameter called VSN_Init_Relative_Freq represents a ratio of users on one specific SN to collective number of users on all SN's. It will be used to initialize Market_VSN_Pattern values. Let's say for footwear, all the brands together have 70M followers on FB. The number of all the followers for footwear products on all social networks is 110M. So the corresponding entry for (footwear, FB) is

$$VSN\_Init \_Relative \_Freq = \frac{70 M}{110 M} = 0.64$$

Following the above procedure, all the entries for Market_VSN_Pattern can be initialized using the corresponding VSN_Init_Relative_Freq values.

Market_Strength

Market_Strength vector for each brand is the proportional presence of a brand in various market types. It reflects the importance of each market for the given brand and the elements are represented in percentile. If a given brand doesn't exist in a particular market, the corresponding weight is zero. It is often a sparse vector since most entries for a vector associated to a brand are zero. It is also a very slowly time-varying parameter that could be updated at most quarterly or after each new product line lunch to reflect the trends on different markets. To make the notation consistent for later expansion, the length of the Matrix Strength vector is set to be equal to the number of all markets, Num_Market. If a particular brand is not active in any market, we set the corresponding entry to zero. For example, BMW is not working in perfume, the entry for its Market_Strength corresponding to perfumes is zero. Data structures such as Bi-JDS may be used to store and access these sparse data types effectively.

Initialization

We start from a uniform distribution over all markets but can adjust the coefficients after greater numbers of user participation, for example after the first 100K users, 1M users and etc.

Brand_VSN_Factor

We define Brand_VSN_Factor to be the strength of a brand on each SN.

$$Brand\_VSN \_Factor = 75 * {\sum }_{i} Market\_Strength ( i ) \times Market\_VSN \_Pattern ( i , j )$$

Where j^{th} column is associated with the target SN. It is the dot product of Market_Strength vector with the corresponding column from Market_VSN_Pattern.

### Example 9

For simplicity, consider only five markets: footwear, apparel, cosmetics, office supply and perfume. The two following brands present only in two markets:

Calvin Klein: apparel, perfume

Ralph Lauren: apparel, perfume

For Calvin Klein, Market_Strength could be something like

[footwear, apparel cosmic, office supply, perfume]=[0 0.70 0 0 0.30]

But for Ralph Lauren it could be different:

[footwear, apparel cosmic, office supply, perfume]=[0 0.85 0 0 0.15]

There are more zero entries corresponding to non-present markets. Now if for Calvin Klein, the corresponding column for Facebook is

$$\begin{matrix}0 \\ \begin{matrix}0.6 \\ 5\end{matrix} \\ 0 \\ 0 \\ 0.4 \\ 0\end{matrix}$$

Since Calvin Klein is active only in two markets, we have only two nonzero entries for the column associated with Facebook. The Brand_VSN_Factor for (CK, FB) is

Brand_VSN_Factor=75*(0.70×0.65+0.30×0.40)=43.125

Which 0.575 reflects the strength of CK over FB.

The corresponding column for Ralph Lauren is

$$\begin{matrix}0 \\ \begin{matrix}0.7 \\ 0\end{matrix} \\ 0 \\ 0 \\ 0.5 \\ 5\end{matrix}$$

So the Brand_VSN_Factor for (RL, FB) is

Brand_VSN_Factor=75*(0.85×0.70+0.15×0.55)=50.77

Brand_Base_Image Sample Parameter List
a) Brand_Self_Image: the self-awareness of each brand toward its image on social networks. It's a scalar in (0-1) range.
b) Base_Impact_Factor: the real value that a brand truly possesses at the time of joining SPO. SPO's analytical engine calculates it.
c) Brand_Network_Value: A measure of size of a brand's networks on all various social networks.
d) Brand_Relative_Size: the relative size of a brand's network to its competitors
e) Brand_Relative_Mapper: The nonlinear function that maps Brand_Relative_Size to (0-1) interval.

Brand_Base_Image can be an initial starting point for building toward the final score assigned to each brand. It is calculated using the following formula

Brand_Base_Image=L_{E}+Brand_Self_Image*Base_Impact_Factor×(U_{E}−L_{E})

For which

0≦Brand_Self_Image≦1

And also

0≦Base_Impact_Factor≦1

Brand_Base_Image evaluates the relative strength of brands on social networks. This parameter is similar to GDP per capita, normalized by the network size to give a fair mean of comparison between current states of activities on different social networks. It serves as a starting point toward building a whole score for each brand. The idea behind limiting this parameter is to incentivize brands not to rely solely on their dominancy in one particular area and incentivize them to perform more social centric activities. A nominal value for L_{E} is 15 and for U_{E} is equal to 25.

Brand_Self_Image

Brand_Self_Image is a scalar factor in (0-1) which reflects the self-awareness and impression of a brand toward its social engagement level. This could be a fair indicator to see where a brand sees itself in comparison to other competitors on social networks. This value is provided by brands at the time they register on SPO.

Base_Impact_Factor

Base_Impact_Factor is a value provided by SPO analytical engine based on current state of social engagement of a brand. This parameter is in the (0-1) range and either constant over time or very slowly time-varying factor. Base_Impact_Factor is calculated through two other factors which are described in the following paragraphs named: Brand_Network_Value and Brand_Relative_Size. This parameters is the mapping of Brand_Relative_Value to the (0-1) interval using an increasing nonlinear function called Brand_Relative_Mapper.

Brand_Network_Value

Brand_Network_Value is calculated for each newcomer brand to SPO as a measure of social network exposure and collective social value capital of the brand. It is related to the capital value possessed by a brand on all social networks. To calculate this quantity, we evaluate Brand_VSN_Factor for all present VSN for the given brand and then add them up:

$$Brand\_Network \_Value = {\sum }_{for all VSN} Brand\_VSN \_Factor$$

Brand_Relative_Size

Brand_Relative_size is the relative strength (engagement and participation) of a brand to its competitors on social networks.

$$Brand\_Relative \_Size = \frac{Brand\_Network \_Value}{Network\_Size}$$

### Example 10

Let's consider a company called XYZ that has joined SPO for the first time and recognizes itself in footwear and apparel markets with the following Market_Strength vector:

Market Stregth=[0.80 0.20 0 0 0]

Evaluating Brand_Base_Image

The brand manager gives a score of 0.90 for Brand_Self_Image at the time of registration on SPO. The SPO analytical engine calculates a value of 0.70 for Base_Impact_Factor. So, the Brand_Base_Image for the XYZ brand is:

Brand_Base_Image=15+(25−15)*0.90*0.70=21.3

Evaluating Social_Activity_Factor

The brand manager has scheduled and run a campaign for all tiers but only available to Facebook (FB) and Twitter users. After closing the campaign, we have following statistics: 10000 tweets, 5000 FB posts, 3500 photos and 500 videos posted on FB.

The corresponding vector of Market_VSN_Pattern for footwear is:

[Facebook, Twitter, Google+, Instagram, Youtube]=[0.45, 0.15, 0.05, 0.30, 0.05]

And for apparel is

[Facebook, Twitter, Google+, Instagram, Youtube]=[0.50, 0.05, 0.05, 0.35, 0.05]

Brand_VSN_Factor for Facebook is

Brand_VSN_Factor=75*(0.45*0.80+0.50*0.20)=38.25

And for Twitter

Brand_VSN_Factor=75*(0.15*0.80+0.05*0.20)=9.75

SN_Influence_Factor

The value of all activities on FB is

5000*1+3500*2+500*5=15000

And the value of all activities on Twitter is

10000*1.3=13000

SN_Influence_Factor for FB is

$$SN\_Influence \_Factor = \frac{15000}{15000 + 13000} \times ( 1 - 0.15 ) = 0.536 \times 0.85 = 0.4556$$

And SN_Influence-Factor for Twitter is

$$SN\_Influence \_Factor = \frac{13000}{15000 + 13000} \times ( 1 ) = 0.536 \times 1 = 0.536$$

Social_Activity_Factor

Using above parameters, we have

Social_Activity_Factor=0.4556×38.25+0.536×9.75=22.65

Brand_Score

The final score assigned to the XYZ brand is

Brand_Score=21.3+22.65=43.95

The above describes, without any intended loss of generality, illustrative mathematical analysis of user-centric parameters and sponsor-centric parameters to generate scores which may benefit evaluation of proposed credit redemptions and facilitate credit redemption or transfer events. Still further and different parameters, algorithms, and mathematical analysis are contemplated and will be recognized by the person of skill in the art.

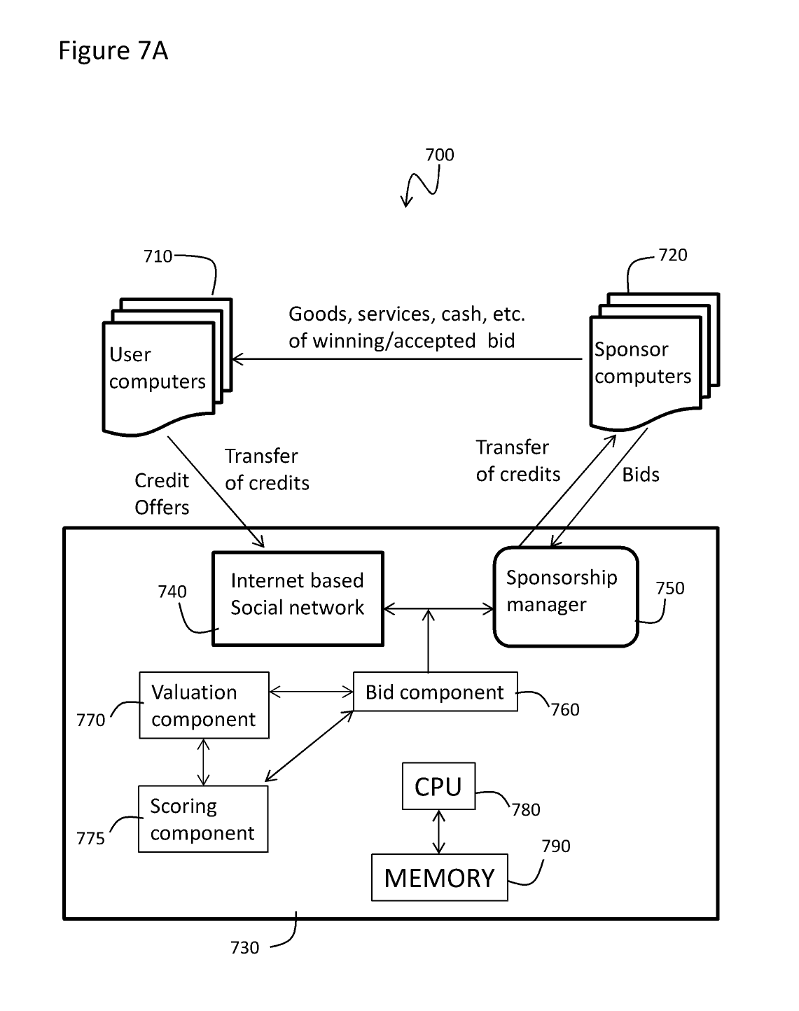

FIG. 7A shows a system map describing an example of an implementation (700) of the system. In the implementation (700) the system comprises a plurality of users (710) each with at least one computing device and plurality of sponsors (720) each with at least one computing device. User computing devices (710) communicate over a network with an interface of a social networking website (740) while sponsor computing devices (720) communicate with an interface for a sponsor manager website (750). The sponsor manager (750) may be embedded in the social networking website (740) and hosted on a server (730) with a processor (780) and a memory (790) operably linked to the social networking website interface (740) and the sponsor manager interface (750). Users and sponsors can access a bid component (760) that is communicative with both sponsor manager (750) and social networking website (740), with a bidding interface displayed on both user computing devices and sponsor computing devices. Bid component (760) is in communication with a valuation component (770). Scoring component (775) is in communication with the valuation component (770) and optionally may be in communication with the bid component (760). The bid component (760), the valuation component (770) and the scoring component (775) are each operably communicative with the processor (780) and memory (790). Memory (790) may include volatile memory such as various RAM types, and non-volatile such as ROM, magnetic storage systems, optical storage systems and the like.

The system map shown in FIG. 7A may be adapted to any geographically distributed or cloud based implementation of the system where functions for maintaining and updating user profiles, monitoring and analyzing user actions, tracking and updating transactional history of each credit, updating and monitoring user and sponsor credit balances, maintaining and updating sponsor profiles, and maintaining and updating sponsor product information and e-commerce platforms, and the like, are distributed over a plurality of server computers and data storage systems. Optionally, the plurality of user computing devices and the plurality of sponsor computing devices can be configured to communicate through a networked server firewall with sponsorship manager website applications hosted on a load balanced web server farm that is communicative with a load balanced database server farm. The load balanced web server farm may additionally be communicative with application interfaces of a plurality of vertical social networks. The sponsorship manager component may optionally be communicative with a payment processor, such as a credit card transaction processor, so that payments may be coordinated with credit purchase requests.

In use, the system for facilitating credit redemptions allows sponsors to effectively engage in many one-to-one relationships with users of a social networking websites in that each user's promotional activity can be independently analyzed and compensated with performance credits based on a predetermined and optionally transparent credits per action correlation established by each sponsor and each user's offer to redeem credits through a bid component may be efficiently evaluated and bid upon.

The system can allow a user to put credits up for auction, showing the due diligence on how the credit was originated giving higher value by association with higher value sponsors and allowing for less credits to be used due to their higher value to obtain a sponsorship level.

The system may provide for credits to be tracked in a database and analyzed for quality to determine valuation or conversion for trade among users and sponsors.

The system provides for analysis of credits, allowing association of influencers and premium brands, and allowing other brands to market through brand affiliation and premium user access and engagement.

The system can plug into any social or vertical network, offer an immediate engagement through sponsorship with a base discount, and monitor each users social media generated content to score such content for alignment with the sponsor's required promotional program, issuing and rewarding the user with credits.

The system can be readily scaled-up to accommodate a plurality of sponsors due in part to each sponsor having to purchase performance credits. Payment for performance credits allows credits to be standardized, allows a reference for the credit value during conversions of one sponsor's credits to another, and prevents sponsors from arbitrarily generating credits.

While the system may benefit all user's particularly in implementations where a base discount level is provided by the sponsors, the system will identify and reward online influencers that perform online promotional actions relating to one or more sponsors. Each user may be provided with a swipe card that encodes the base discount level and then may be provided with further discount coupons or discount badges as performance credits are accumulated to achieve predetermined credit thresholds for access to greater discount levels. The card may be virtual in the form of a mobile application for example, whereby the user checks in to a sponsor location and the discount code is automatically downloaded to the mobile device and scanned at the point of sale to apply the discount on purchases. The discount scan code can be provided by the sponsor by uploading a specific discount code associated with each discount level, with the appropriate code downloaded at check in to the user mobile device at the sponsor's location. The sponsor may bundle promotions with the discount code that in addition to the discount level the user is at may be added to the discount as a one time, daily, weekly, monthly or annual incentive on specific products and services. The sponsor can maintain this additional promotion on the system by setting criteria such as duration of the offer, specific product and service offering, discount and incentive etc. These promotions can be added at any time by the sponsor and added to any discount level differently.

Based on comparisons and analysis of the users promotional action history and performance credits transaction history, the system may be able to identify opinion leaders and opinion seekers. Opinion leadership is the process by which people (the opinion leaders) influence the attitudes or behaviors of others (the opinion seekers). Both opinion leaders and opinion seekers are significant for promotion of a sponsors brand name and products. The Internet not only provides opinion leaders with efficient ways to disseminate information, but also greatly facilitates information searching for opinion seekers.

Opinion leaders are defined as individuals who transmit information about a topic or product to other people, in terms of the extent to which information is sought by those people. Many opinion leaders may also be opinion seekers because they desire more knowledge or expertise, partly due to their interest in a specific topic or product. Opinion seekers look for information or advice from others when making an informed decision or taking action. When they perceive a risk in a certain situation, when they are not familiar with a topic or product, or when they find others' experience to be useful, they may actively seek out information or advice to inform their decision. Opinion seeking is a significant component of promotional communication because it facilitates information diffusion in the interpersonal communication process. Opinion leaders cannot exist without opinion seekers, and vice versa. Accordingly, the system, and method for providing the same, may reward both opinion leaders (for example, for posting a testimonial) and opinion seekers (for example, for interactions with the testimonial such as searching, reading, commenting, clicking and the like).

The system may be used in combination with an existing computer-mediated social network where users within a community come together for a common cause, topic or subject matter, such as friends like Facebook, profession like doctors or contractors, social causes like giving, health, community, etc. Alternatively, the system may be used to build such computer-mediated social networks.

The system may be used with any horizontal or vertical computer-mediated social network or any combination thereof. General social networking platforms such as Google+, Instagram, MySpace, Facebook, LinkedIn and Twitter are horizontal social networks as online users are not united by a specific subject matter, topic, interest or value. By comparison, vertical social networks are regarded as online social communities that are maintained by individuals to exchange a shared subject matter, topic, interest or value with current and potential community members in an ongoing manner. Vertical social networks can exist within horizontal social networks or can be formed independent of horizontal social networks. An example of a vertical social network within a horizontal social network is a celebrity such as Justin Beiber or Michael Jordan and their network (vertical) within the Facebook (horizontal) platform.

The system can provide users of the social network an opportunity to connect with and engage one or more sponsors such as major brands, regional brands and vertical or specialized brands together. The sponsor offers an immediate benefit through this connection to the user with a base discount on all or certain products, ie. goods and/or services offered by the sponsor. The user engages with the sponsor one to one by using this base discount and can choose to further engage with the sponsor by performing promotional actions that benefit the reputation of the sponsor within this social network to be provided with performance credits. The user can choose to engage as much or as little as they wish.

The system may provide prompts in a convenient context dependent manner to encourage the user to perform a promotional action within the social network such as comments, check in to the brands store (physical or virtual), tweeting, posting commentary on goods, services, location, scanning product pictures, posting pictures and videos. The system may also provide complementary or gift credits to the user to encourage participation. The social network may also contribute performance credits to the user for activities that are not sponsor or brand specific, like filling out their complete profile, logging in, amount of engagement time on the system, interacting with other users.

The sponsor purchases credits from the system in order to give them away to the user for promoting the sponsor. As more credits are rewarded and accumulated specific to the sponsor the user may accumulate sufficient holdings of the sponsor specific credits to reach a credit threshold to gain access to a greater discount level to purchase the sponsor's product(s). The sponsor may define the number of discount levels that are available to be unlocked and accessed by the user with sufficient accumulation of credits, what discount will be offered at each level, the credit threshold to gain access to each discount level, and the strategy for earning credits within each level or tier.

As a user gains access to a greater discount level, the sponsor can provide to the user a discount code associated with the greater discount level and compatible with the sponsor's discount scan code used at point of sale devices. Each download and usage of the discount code can get logged and potentially constitute a user action to earn further credits. This discount code can be retrieved or automatically downloaded to a smart phone app and used when a user checks out with their purchase at the sponsor's point of sale location

The sponsor can set credit allocation criteria by specifying how many credits are to be transferred for each action and specifying by how many repetitions by a user are allowed for each specific action. For example, for a particular discount level if the sponsor specifies a multiple or repetition of three for an action mentioning a sponsor's brand name, then a user mentioning the brand name for a fourth in that discount level would not be awarded credits for the naming action.

The system can monitor user actions and the credits earned and held in user accounts and can encourage or prompt the user to deploy different strategies to earn more credits. For example, game dynamics can be deployed to show how many credits are held by the user in total and for each sponsor, what the user needs to do to earn more credits, how the user ranks relative to peers within the social network. Any ranking method may be used, for example a ranking based on engagement indexes and scores, on rate of credits being earned (who earned them the fastest), who has the highest engagement with specific sponsors.

The tiered discount levels may be graphically represented by badges. Badges may be purchased and issued by the sponsor to the user to allow access to an associated discount level. The badges can appear in the user profile web page identifying the sponsor that issued the badge. A fee for issuing the badge may be justified as the greater the discount level the obtained by the user, indicates a greater influence of the user within the social network and the more valuable the user is to the sponsor and the sponsor's brand, and the greater the cost to the sponsor to engage this user. Thus badges, like performance credits are purchased and allocated to the user based on predetermined and optionally transparent criteria set by the sponsor. The higher the discount level the user attains the more expensive the corresponding badge, providing a mechanism and reference to set the price on the influencers within the network.

If the sponsor issues performance credits to the user (sponsor allocated credits) and the system issues credits to the user (system credits) and the sponsor subsequently leaves the social network, the user can redeem these credits with appropriate credit conversions to achieve credit threshold to gain access to a discount level provided by another sponsor, thus creating a market for credits, and providing an ability for competing and/or complementing sponsors to acquire influencers. For example, a sponsor may be able to identify influencers within the social network based on user rankings and offer an incentive to the influencer by reducing the credit threshold or provide attractive conversion rates for entry into the sponsor's higher discount level tiers. As a more specific example, if the sponsor's top tier requires 10,000 credit to be earned in order to gain access by the user, and the sponsor identifies an influencer within the social network, the sponsor can discount the entry level from 10,000 to 5,000 incenting the influencer to join and engage. Then the rules of engagement within that tier are specified by the sponsor for this newly engaged influencer to earn credits.

As the user accumulates sponsor specific and system credit holdings, the user may choose to use the credit holdings to gain access to discount levels of other sponsor's that may not be prominent in the user's credit profile but that the user wishes to engage. Rules may be set to guide the conversion of a user's sponsor specific credits to other sponsor that are not competing but are complementary in deference to the civility and cooperative objectives of most social networks. For example, the user can offer credits to sponsors in an open notice and have the sponsors bid for the user, stating the discount level the sponsor is prepared to offer the user and for how many credits. When a user offers credits in a bid market, due diligence can occur by interested sponsors to determine how these credits were earned, for example the value of the credits may be positively correlated to the value of the sponsor that allocated them, such that credits may be deemed to be of a higher value if the credits were allocated by a premium brand. Thus, a sponsor considering bidding for credits in a bid market may discount or raise the value of credits depending on how they were originated and their transactional history. This allows the sponsor to align to desired brand influencers within the social network. If the credits were shown as purchased from the system and were not earned then they hold a lower value. If they are combined with credits that were earned and allocated through high quality promotional engagement from a high quality brand then the percentage of credits as the total offering can be analyzed. The sponsor may choose not to penalize the user for buying credits and combining them with high quality sponsor/activity allocated credits.

The system provides a marketplace for influencers to offer their promoting services to sponsors. Sponsors may compete for influencers of all levels offering influencers reductions from the sponsor's credit threshold requirements.

Users can transfer credits to their friends (other users) to help them out as socially responsible and gifting within the network. For example, credits may be gifted for free, credits may be loaned with a time period, or credits may be loaned with an interest rate (credits loaned for 1 year plus 50 credits). Users may be incented to gift and system credits can be transferred to the user that creates the gift as a way to encourage social responsibilities. Social initiatives can be launched within the social network in which user can donate credits to a cause. The cause (a user) can then use the donated credits to gain access to discount levels with sponsors and use this discount to reduce the costs of the cause.

Users can inspect and analyze their credits activity in a history log, for example credits used, earned, bought, transferred and what action created the credit allocation such as a post, a mention and with which sponsor. The user can see their sponsor engagement score, how they rank among other users with a certain brand, all within for example, a user account dash board format.

When a user applies to gain access to a sponsorship level of a sponsor, the sponsor can perform due diligence on the user analyzing how the user obtained their credits to earn influencer status, which brands they engaged with, how long it took to earn these credits, social contribution score, etc., and decide if they accept the influencer into their sponsorship level. The sponsor can define automatic acceptance criteria such as brands, and brand cluster the influencer has engaged with, or rate of accumulation and type of user engagement as an overall percentage of total engagement. The sponsor can define the logic for automatic acceptance and which applications for sponsorship get manually reviewed.

The system may include an application software installed on a user's mobile computing device that keeps the user connected to the system whenever the device is turned on. Using check-in geolocation technology the mobile application software can determine which sponsor's location has been entered and automatically download the correct discount scan code based on the discount level the user is currently at. The mobile application can allow the system to provide the user with context relevant prompts, such as prompts to the user detailing a number of purchases or actions specific to the sponsor, and perhaps even specific to the sponsor location, in order to earn sponsor specific credits or to move to a greater discount level. The system may also communicate and offer a sponsor's daily specials to the user that checked-in to the sponsor's location.

Sponsor purchases of credits cooperate with tiered discount levels and/or array of plurality of actions and credits per action to promote user and sponsor engagement with each other and with the system. Having sponsors pay to purchase credits and then further providing users with a discount may seem to be counterintuitive as both aspects appear to favor the user. However, the sponsor's motivation is that the two aspects cooperate to generate user engagement and purchases of the sponsor's products. The purchase of credits by the sponsor is useful to allow a level and controlled playing field for a plurality of sponsors. The purchase of credits provides an inherent reference and oversight mechanism for credit circulation. The input cost of the sponsors to purchase credits can be balanced by a benefit back to sponsors. The tiered discount levels and/or the credits per action array provide a user engagement greater than conventional reward point schemes of providing a user points and having them redeem points, because with the sponsorship management system described herein the user is continuously provided with greater opportunity if they remain engaged with the sponsor brand and products. Bundling further promotions with discount levels, such as adding a specific daily special above and beyond the discount level, encourages further engagement. For example, if the user is at a sponsor's top level, the sponsor (eg. Avis Rent a Car) may decide that all top tier users will get 2 days free on top of the top level discount and the top tier users promote the additional 2 days free once they take it, motivating other users by promoting the benefits of top level engagement. In the sponsor's interest, the additional promotions, such as 2 days free from Avis Rent a Car, can be used to help clear out inventory or sell off capacity and offers the sponsor inventory management and controls to move goods and services that may be lagging in inventory.

An example of the system and several of its variants have been described above for illustrative purposes without any intended loss of generality. Further illustrative variants and modifications will now be described. Still further variants, modifications or combinations thereof will be recognized by the person of skill in the art.

The system may accommodate a great degree of variability or diversity with respect to criteria for allocating, transferring, converting, and/or tracking credits. Furthermore, mechanisms for setting the criteria may vary according to a desired implementation. Still further, the criteria may relate to each credit or an increment or packet of credits depending upon a desired implementation. However, throughout various implementations of the system a constant feature will be that sponsors will purchase credits. The entirety of credits held in a sponsor's account need not have been purchased. For example, a newly enrolled sponsor or user may receive gifted credits as part of a welcome package. The system may gift credits to a sponsor or user for any suitable reason such as recognition of longevity, outstanding social activity, or in a more general example, as an incentive to enhance participation in the system. Furthermore, users may be given opportunities to purchase credits. Thus, the entirety of the credits circulating in the system need not be sponsor purchased credits. The proportion of total circulating credits that relate to sponsor purchased credits may be quantified by at least calculations. First, typically at least 30% of credits circulating in the system at any given time will be the cumulative sum of currently owned sponsor purchased credits and credits previously purchased by sponsors. For example, at any given time the cumulative sum of currently owned sponsor purchased credits and credits previously purchased by sponsors may be greater than 40%, 50%, 60%, 70%, 80%, 90% of the total credits circulating in the system. A second quantification of the proportion of total circulating credits that relate to sponsor purchased credits can be determined by identifying the percentage of total credits circulating in the system that originated as sponsor purchased credits. A credit is considered to have been originated as a sponsor purchased credit if the initial transfer of a credit within the system is in exchange for payment provided by a sponsor. Typically, at least 30% of credits circulating in the system at a given time will have originated as sponsor purchased credits. For example, at any given time the aggregate of credits originated as sponsor purchased credits may be greater than 40%, 50%, 60%, 70%, 80%, 90% of the total credits circulating in the system. In both quantifications, a level of greater than 50% will generally be associated with efficient functioning of the system.

Credits can be controlled and held by an administrator of the system, for example within a treasury component or a credit bank, which terms are used interchangeably to describe a repository of credits that are held by an administrator of the system, secured and arms-length from all sponsors and users. The treasury component or credit bank of the system may establish a reference value for credits. The reference value established by the treasury component may be a par value, an issuance value, a buyback value or any other consistent manner of determining a reference value of credits in circulation.

To illustrate a function of the treasury component, FIG. 7B shows the treasury component 795 included in the system 700 shown in FIG. 7A. The treasury component 795 can receive information from a credit purchase request from the sponsorship manager 750 and return credits to the sponsorship manager 750 for subsequent transfer as sponsor-purchased credits to a sponsor account. The treasury component 795 is communicative with a payment processor 796, for example a credit card transaction processor, and receives confirmation of payment corresponding to the credit purchase request prior to authorizing transfer of credits to the sponsor account. The treasury component 795 may also be communicative with the valuation component 770 to provide a reference value for credits. The treasury component can be configured to store, manage, monitor and disburse credits. For example, the treasury component may update the quantity of sponsor-purchased credits in each sponsor record in response to receiving a credit purchase request from a sponsor identified in the sponsor record. In another example, the treasury component may monitor circulating credits and remove or add credits based on predetermined criteria to control inflation/deflation of the reference value of credits. In another example, the treasury component receives notification of a transfer of credits and logs the information relating to the transfer. The treasury component will typically be secured and inaccessible by direct communication from sponsors or users.

The system map shown in FIG. 7B may be adapted to any geographically distributed or cloud based implementation of the system where functions for maintaining and updating user profiles, monitoring and analyzing user actions, tracking and updating transactional history of each credit, updating and monitoring user and sponsor credit balances, maintaining and updating sponsor profiles, and maintaining and updating sponsor product information and e-commerce platforms, and the like, are distributed over a plurality of server computers and data storage systems.

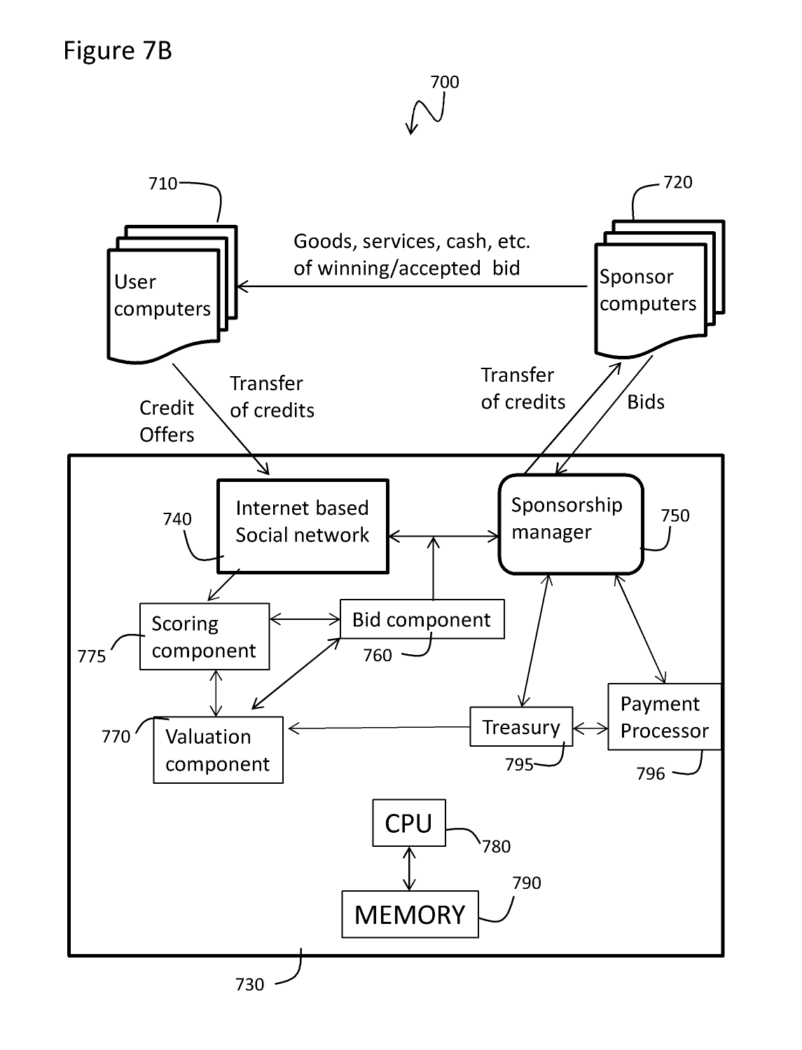

Many different conversion schemes to convert a first sponsor's credits to a second sponsor's credits may be accommodated by the system. For example, the second sponsor may provide an offer of conversion to a first sponsor or a user holding first sponsor allocated credits with the offer being accepted or rejected at the discretion of the first sponsor or user, respectively. Another example of a conversion scheme is shown in FIG. 8. The system provides a clearinghouse for credits that establishes conversion factors based on a ranking of sponsor's engagement quantified by the number of users holding a sponsor's allocated credits. In the example shown in FIG. 8, a credits database (810) may be processed by either in-database analytics or fetching the data to a separate analytics server to determine the number of users holding sponsor allocated credits for each of sponsor #1 (820), sponsor #2 (830) and sponsor #3 (840). Sponsor #1 is ranked in the highest bracket which has a conversion factor of 3 to transfer credits to the clearinghouse of the system, sponsor #2 is ranked in the medium bracket with a conversion factor of 2 to transfer credits to the clearinghouse, and sponsor #3 is ranked in the lowest bracket with a conversion factor of 1 to transfer credits to the clearinghouse. Transfer from the clearinghouse back to sponsors #1, #2 or #3 is the inverse of the respective conversion factors stated in the preceding sentence. The conversion factors may be used to determine not only the conversion between a sponsor's credits and the clearinghouse credit, but also the conversion between a first sponsor's credits and a second sponsor's credits. For example, to determine the conversion of 300 credits of sponsor #2 to sponsor #1 credits, the 300 credits is multiplied by a factor of 2 to convert to the clearinghouse value and then multiplied by a factor of 1/3 to convert from the clearinghouse value to the sponsor #1 value. Executing the two conversion calculations together results in multiplying the 300 credits of sponsor #2 by 2/3 to convert to 200 credits for sponsor #1. Conversely, a conversion of 300 credits of sponsor #1 is multiplied by 3/2 to convert to 450 of sponsor #2 credits. Many other conversion schemes may be used.

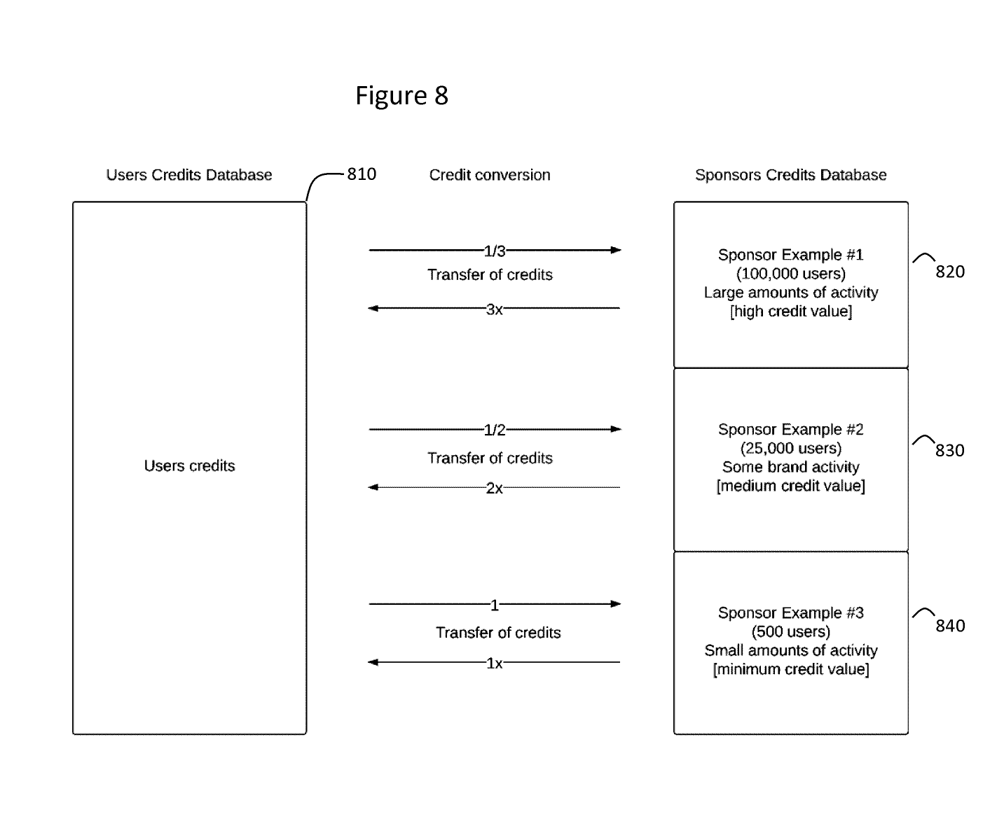

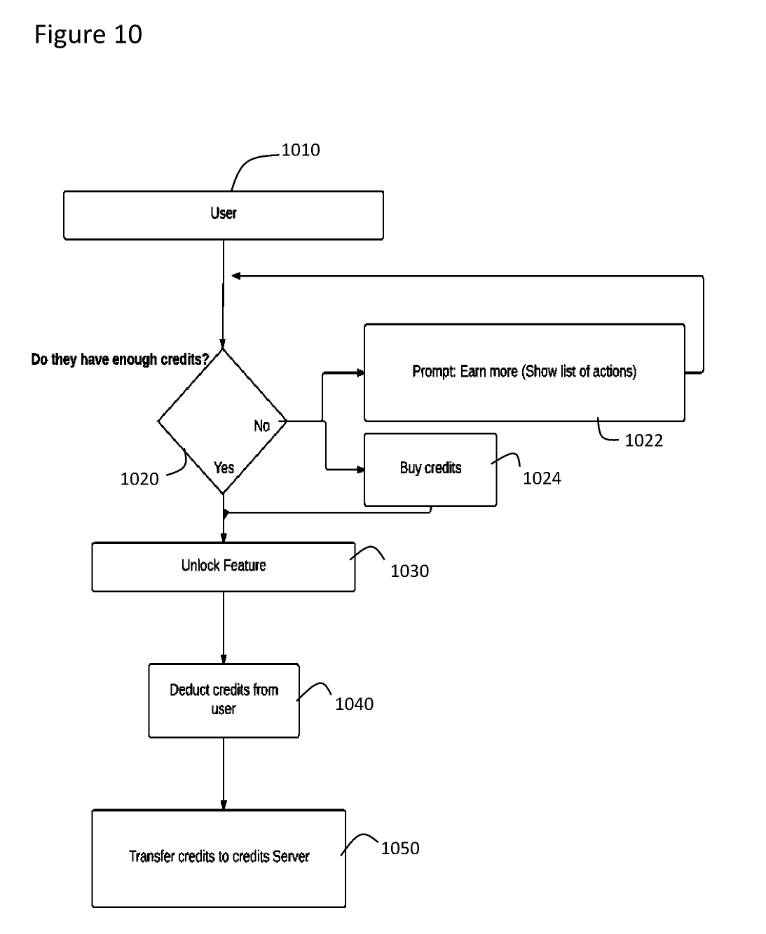

A credit tracking component for logging the transactional history of each credit or each predetermined increment or packet of credits is not critical to the system, since the system may function by recognizing a current holder of a credit without requiring information relating to previous holders. However, a credit tracking component does provide an advantage when included. For example, analysis of the transactional history of credits may increase the rate at which system prompts provided by the system are acted upon by users or may allow the system to identify brand associations between different sponsors. Credit tracking mechanisms will typically involve a log server to register each purchase, allocation, transfer, conversion, redemption and the like to document a history for each credit or each increment or packet of credits as desired. FIGS. 9 and 11 together show an example of tracking credits. In FIG. 9 a notice is sent (910) to the sponsor advising of a low credit balance. The sponsor inspects the credit balance (920) and purchases credits (922) if the credit balance is judged to be low. Otherwise, if the sponsor deems the credit balance to be sufficient (930) then credits are not purchased. The sponsor may be prompted or wish of their own accord (940) to set up an array of actions (942) with each action correlated to a credit value (944). If the actions array is established then user actions are monitored (950), and validated user actions result in the user's credit balance being increased by the credit value set in the actions array with a corresponding deduction in the sponsors credit balance. Within the context of FIG. 9, FIG. 11 shows a specific example of updating sponsor (1110) and user (1120) credit balances by a credits server (1130) as well as communication between the credits server (1130) and a log server (1140) to update the transactional history to reflect the transfer of each credit from the sponsor (1110) to the user (1120).

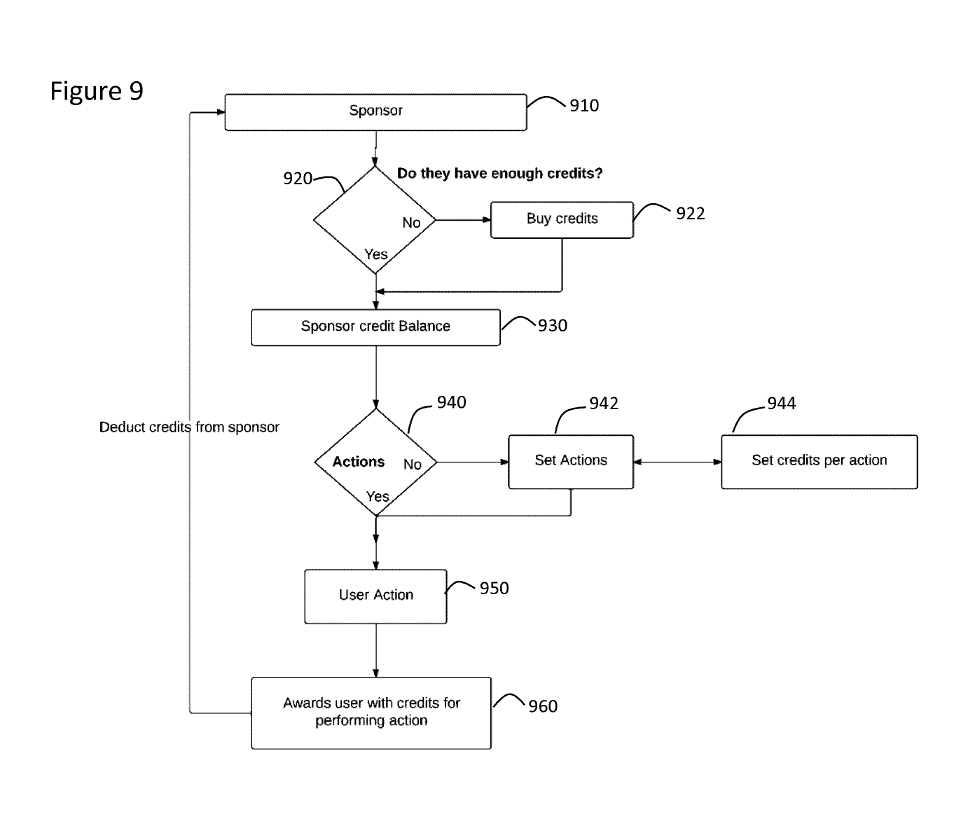

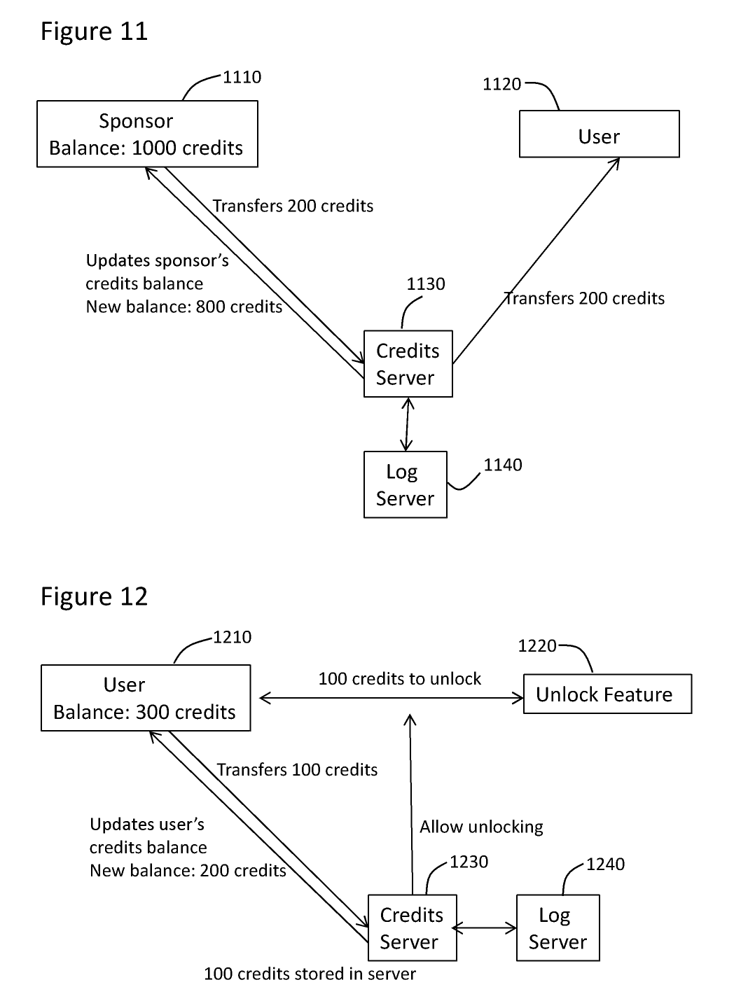

FIGS. 10 and 12 together show another example of tracking credits. In FIG. 10 a notice is sent (1010) to a user advising of a credit balance approaching a credit threshold to unlock and gain access to a desired feature. The user inspects the credit balance (1020) and either performs further promotional actions (1022) or purchases credits (1024) if the credit balance is lower than the credit threshold for the feature. Once the credit balance is equal to or greater than the credit threshold the feature is unlocked (1030) and the user's credit balance is decreased (1040) by an amount equal to the credit threshold value and corresponding amount of credits are transferred to a clearinghouse or credits server of the system (1050). Within the context of FIG. 10, FIG. 12 shows a specific example of updating a user (1210) credit balance by a credits server (1230) in order to unlock a feature (1220) desired by the user, as well as communication between the credits server (1230) and a log server (1240) to update the transactional history to reflect the transfer of each credit from the user (1210) to the credits server (1230). In an alternative embodiment, a feature may be unlocked without deducting credits from a user's account. For example, the feature is unlocked (1030) to provide incentive for the user to achieve a credit balance that is equal to or greater than a predetermined credit threshold to unlock the feature, without any transfer of credits taking place.

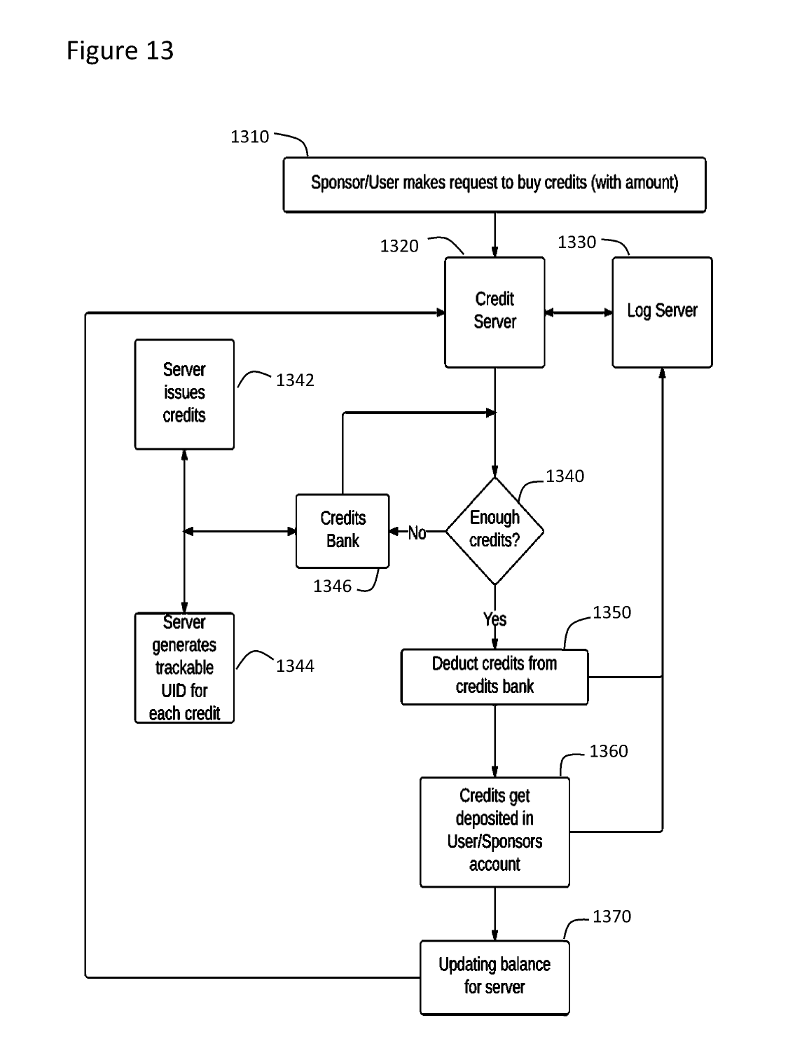

FIG. 13 shows yet another example of tracking credits. A sponsor or a user can make a request to purchase credits specifying the desired quantity of credits to be purchased (1310). The credits server receives the request (1320) and determines whether sufficient credits are available to satisfy the request (1340) based on a query of the quantity of credits in a credits bank (1346). If the credits in the credits bank is insufficient then the credits server issues credits (1342) with each credit associated with a trackable unique identifier (1344). Otherwise, if the credits bank holds a sufficient quantity of credits, then a quantity of credits equal to the quantity specified in the request (1310) is deducted from the credits bank (1350) and the credit balance of the user/sponsor account is increased (1360) and the credit balance of the credits server is decreased (1370) accordingly. In addition, the credits server (1320) sends a request to a log server (1330) to update the transactional history of each credit to reflect the transfer of each credit from the credits server (1320) to the user/sponsor.

The system may accommodate many scoring, rating or ranking techniques to gauge a user's or a sponsor's social network activity, impact, influence, and the like. The scores or ratings may fall within a bounded range or unbounded range. A bounded range is characterized by a defined upper and lower limit, and allows for easy comparison of scores falling within the range. A bounded range of 300-800 for User_Social_Capital or a bounded range of 0-100 for Brand Score are merely illustrative, and a bounded range may have any upper limit and any lower limit as desired. Typically, all users may be scored and ranked within a common bounded range for at least one user score type. Typically, all sponsors may be scored and ranked within a common bounded range for at least one user score type. The bounded range for users and sponsors may be same or different.

The valuation and scoring components of the system may be used to provide an adjusted amount of credits offered for redemption for any credit redemption event, and need not be limited to a bidding mechanism. For example, in addition to a bid mechanism, other credit redemption events could include an exchange, a sale, a cash out, and the like.

The system may also accommodate various mechanisms for monitoring promotional actions of users. An example of an iterative analysis of user actions to identify and validate promotional actions was shown in FIG. 3. Another example is for promotional actions to be guided by software wizards or setup assistants (a user interface type that presents a user with a sequence of dialog boxes that lead the user through a series of well-defined steps) that validate and code the action as it is performed allowing for real time allocation of credits. Servers tasked with a monitoring function may validate each user action and/or send an approval or denial for allocation of credits.

The system may also accommodate various schemes for allocating sponsor purchased credits. The allocation of credits will typically be influenced by criteria selected and set by sponsors, such that each sponsor will be able to manage or adjust criteria to balance considerations such as cost and level of user engagement as each sponsor is provided with feedback information in their accounts, for example relating to type and amount of user activity and corresponding credit allocations. At least a portion of the criteria will provide allocation of credits based primarily on the user's actions and independent of any other user acting upon or following the user's actions.

The system can tolerate variability in structuring discount levels and the credit threshold values to achieve them. These may be guided or set by the system, may be sponsor defined, or a combination of both where the sponsor selects from predetermined options set by the system. Typically, all sponsors will provide a base discount level, for example ranging from 5% to 20%, to all users independent of the user's credit balance. Providing such a base discount level provides an immediate benefit to engage users. Further, discount levels may range between 10% to 100%. An example of discount level ranges is 5 to 20% for the first base discount level, 10% to 30% for the second discount level, 20% to 40% for the third discount level, 30% to 50% for the fourth discount level. Discount levels may be unlocked for a user by providing the user with a purchase code that may be graphically represented with the user's account as a discount coupon or badge.

Discount codes, credit holdings and other user account information may be accessed by any convenient technology including swipe, tap or chip cards and mobile application software for requesting codes and user account information. Accessing user account information by swipe, tap or chip cards and mobile application software are typically useful for user purchases and actions at a sponsor's point of sale location.

The components of the system may be administered by a single organization or a plurality of partnering organizations. The selling and/or tracking of credits, for example, may be administered by an organization at arm's length from the organization administering the rest of the system. Such an arm's length organization may be a financial institution, accounting firm or payment transaction processor.

The system may accommodate any type of end-user computing device and any type of sponsor computing device provided the computing device can be networked to the system and is configured to display website interfaces and graphical interface elements for performing the various functions of the system such as performing promotional actions or establishing credits per action correlations for awarding performance credits. For example, the computing device may be a desktop, laptop, notebook, tablet, personal digital assistant (PDA), PDA phone or smartphone, gaming console, portable media player, and the like. The computing device may be implemented using any appropriate combination of hardware and/or software configured for wired and/or wireless communication over the network.

The server computer may be any combination of hardware and software components used to store, process and/or provide purchase, tracking and management of performance credits and monitoring and analyzing promotional actions. The server computer components such as storage systems, processors, interface devices, input/output ports, bus connections, switches, routers, gateways and the like may be geographically centralized or distributed. The server computer may be a single server computer or any combination of multiple physical and/or virtual servers including for example, a web server, an image server, an application server, a bus server, an integration server, a user profile server, a user actions server, a credits tracking server, a log server, a credits balance server, a sponsor profile server, a sponsor product server, an accounting server, a treasury server and the like.

A server-client computing architecture has been described for illustrative purposes. The system can also be readily implemented in a peer-to-peer configuration.

Any conventional computer architecture may be used to implement the system including for example a memory, a mass storage device, a processor (CPU), a Read-Only Memory (ROM), and a Random-Access Memory (RAM) generally connected to a system bus of data-processing apparatus. Memory can be implemented as a ROM, RAM, a combination thereof, or simply a general memory unit. Software modules in the form of routines and/or subroutines for carrying out features of the sponsorship management system can be stored within memory and then retrieved and processed via processor to perform a particular task or function. Similarly, one or more of the flow diagrams shown in FIGS. 1-4 and 8-13 may be encoded as a program component, stored as executable instructions within memory and then retrieved and processed via a processor. A user input device, such as a keyboard, mouse, or another pointing device, can be connected to PCI (Peripheral Component Interconnect) bus. The software will typically provide an environment that represents programs, files, options, and so forth by means of graphically displayed icons, menus, and dialog boxes on a computer monitor screen.

A data-process apparatus can include CPU, ROM, and RAM, which are also coupled to a PCI (Peripheral Component Interconnect) local bus of data-processing apparatus through PCI Host Bridge. The PCI Host Bridge can provide a low latency path through which processor may directly access PCI devices mapped anywhere within bus memory and/or input/output (I/O) address spaces. PCI Host Bridge can also provide a high bandwidth path for allowing PCI devices to directly access RAM.

A communications adapter, a small computer system interface (SCSI), and an expansion bus-bridge may also be attached to PCI local bus. The communications adapter can be utilized for connecting data-processing apparatus to a network. SCSI can be utilized to control a high-speed SCSI disk drive. An expansion bus-bridge, such as a PCI-to-ISA bus bridge, may be utilized for coupling ISA bus to PCI local bus. PCI local bus can be connected to a monitor, which functions as a display (e.g., a video monitor) for displaying data and information for an operator and also for interactively displaying a graphical user interface.

A database can contain information on a variety of matters such as data relating to credit allocation, tracking, and conversion. For example, a database may contain user profiles, user actions, sponsor profiles, product profiles, credit transaction history and/or credit conversion information. A user profile may include, but is not limited to, a user identifier such as login name, a password, contact information, mailing information, billing information, saved product searches, and/or user preferences for use in searching database and/or displaying product searches. A sponsor profile may include, for example, sponsor identifier such as a login name, a password, contact information, mailing and/or shipping information, billing and/or invoicing information, and/or offer information. For example, offer information may include an offer to be promoted from a first discount level to a second discount level correlated to a credit threshold value.

A database can also maintain information to incorporate an e-commerce platform for participating sponsors. Typically, the database can include sponsor product, such as a good or a service, information including, for example, a UPC code, a product description, credits for purchasing a product, a current item quantity, a product image gallery, warranty cost, a minimum cost, a product weight which is used as part of the shipping costs, an extended product description, and the like.

The system may be implemented by incorporating existing technologies. Table 1 provides an example of a contemplated technology stack as well as suitable alternatives.

TABLE 1
Illustrative technology stack for implementing the system.

| | Technology | Alternative Technology |
|---|---|---|
| Server | NGINX, PASSANGER | APACHE |
| Database | MONGODB | MYSQL, POSTGRESQL, MS |
| | | SQL, ORACLE, ACCESS, |
| | | CASSANDRA, COUCHDB, |
| | | HBASE (HADOOP), ETC |
| Back-end | RUBY ON RAILS | PYTHON/DJANGO, PHP, |
| | | ASPX, SCALA, JAVA, C/C++ |
| Front-end | HTML5, CSS3, | HTML, CSS3, FLASH |
| | JAVASCRIPT, JQUERY, | |
| | COFFEESCRIPT, | |
| | JSON, XML | |

The network may be a single network or a combination of multiple networks. For example, the network may include the Internet and/or one or more intranets, landline networks, wireless networks, and/or other appropriate types of communication networks. In another example, the network may comprise a wireless telecommunications network (e.g., cellular phone network) adapted to communicate with other communication networks, such as the Internet. Typically, the network will comprise a computer network that makes use of a TCP/IP protocol (including protocols based on TCP/IP protocol, such as HTTP, HTTPS or FTP).

The system may be adapted to follow any computer communication standard including Extensible Markup Language (XML), Hypertext Transfer Protocol (HTTP), Java Message Service (JMS), Simple Object Access Protocol (SOAP), Representational State Transfer (REST), Lightweight Directory Access Protocol (LDAP), Simple Mail Transfer Protocol (SMTP) and the like.

The system may accommodate any type of still or moving image file including JPEG, PNG, GIF, PDF, RAW, BMP, TIFF, MP3, WAV, WMV, MOV, MPEG, AVI, FLV, WebM, 3GPP, SVI and the like. Furthermore, the system may accommodate any conventional methods of image analysis to identify the promotional merit of a posted image.

The system may guide or prompt user attempts at performing promotional actions by any convenient form of user interface element including, for example, a window, a tab, a text box, a button, a hyperlink, a drop down list, a list box, a check box, a radio button box, a cycle button, a datagrid or any combination thereof. Furthermore, the user interface elements may provide a graphic label such as any type of symbol or icon, a text label or any combination thereof. The user interface elements may be spatially anchored or centered around a portion of the user's social networking page dedicated to providing information relating to the user's credit balance and credit transactional history. It will be recognized however, that any desired spatial pattern or timing pattern of appearance of user interface elements may be accommodated by the system. Any number of promotional actions may be associated with performance credits, and each action may be represented by one or more user interface elements as desired.

In a certain example, the system is useful for facilitating a credit redemption from a user. The system comprises a storage system for storing a plurality of user records and a plurality of sponsor records, each user record comprising a user identifier and a quantity of credits allocated to the user and at least one score relating to the user's social network influence and each sponsor record comprising a sponsor identifier, a quantity of sponsor-purchased credits and at least one score relating to the sponsor's social network influence. The system is connected to a network, such as the Internet, and includes a networked interface device for receiving from a user a redemption offer for a quantity of credits held in the user's account, the redemption offer being open for bids from at least one sponsor. A processor operably connected to the networked interface device and the storage system performs a valuation analysis of the redemption offer to determine an adjusted value for the quantity of credits based on at least one user score and returns the adjusted value to the user and/or the at least one sponsor prior to prompting a bid from the at least one sponsor. Aspects of the system may be further defined in several illustrative examples. In one example, the valuation analysis may also consider at least one sponsor score. In another example, the redemption offer is open for bids from a plurality of sponsors. When the redemption offer is open for bids from a plurality of sponsors, the user may be allowed to specify and/or select the plurality of sponsors. In another example, the valuation analysis considers at least one user score and at least one sponsor score for each possible pairing of the user with each of the plurality of sponsors selected by the user; optionally, the adjusted value for each user and sponsor pairing may be returned to all of the plurality of sponsors selected by the user. In another example, the adjusted value is formatted as an absolute value, a multiple, a percentage, or a differential. In another example, the user score is determined based on a plurality of user-centric parameters extracted from one or more of user action history, credit transaction history, and user social networking history. In another example, the user score is based on user interaction with first order and second order neighboring nodes in a social network graph. In another example, the user score is a simple moving average of a plurality of user scores previously generated and recorded at regular intervals. In another example, the user score is based on information obtained from a plurality of social networks. In another example, the user score is bound by a range with an upper limit and a lower limit. In another example, the sponsor score is determined based on a plurality of sponsor-centric parameters extracted from one or more of credit transaction history, sponsor credit purchase history, sponsor credit allocation history, sponsor social networking history, and sponsor website traffic.

In a certain example, a method for facilitating a credit redemption may be implemented using a networked computer system. The method can include steps of: storing a plurality of user records, each user record comprising a user identifier and a quantity of credits allocated to the user and at least one score relating to the user's social network influence; storing a plurality of sponsor records, each sponsor record comprising a sponsor identifier, a quantity of sponsor-purchased credits and at least one score relating to the sponsor's social network influence; receiving from a user a redemption offer for a quantity of credits held in the user's account, the redemption offer open for bids from at least one sponsor; and performing a valuation analysis of the redemption offer to determine an adjusted value for the quantity of credits based on at least one user score and returning the adjusted value to the user and/or the at least one sponsor prior to prompting a bid from the at least one sponsor. Aspects of the method may be further defined in several illustrative examples. In one example, the valuation analysis may also consider at least one sponsor score. In another example, the redemption offer is open for bids from a plurality of sponsors. When the redemption offer is open for bids from a plurality of sponsors, the user may be allowed to specify and/or select the plurality of sponsors. In another example, the valuation analysis considers at least one user score and at least one sponsor score for each possible pairing of the user with each of the plurality of sponsors selected by the user; optionally, the adjusted value for each user and sponsor pairing may be returned to all of the plurality of sponsors selected by the user. In another example, the adjusted value is formatted as an absolute value, a multiple, a percentage, or a differential. In another example, the user score is determined based on a plurality of user-centric parameters extracted from one or more of user action history, credit transaction history, and user social networking history. In another example, the user score is based on user interaction with first order and second order neighboring nodes in a social network graph. In another example, the user score is a simple moving average of a plurality of user scores previously generated and recorded at regular intervals. In another example, the user score is based on information obtained from a plurality of social networks. In another example, the user score is bound by a range with an upper limit and a lower limit. In another example, the sponsor score is determined based on a plurality of sponsor-centric parameters extracted from one or more of credit transaction history, sponsor credit purchase history, sponsor credit allocation history, sponsor social networking history, and sponsor website traffic.

The system described herein and each variant, modification or combination thereof may also be implemented as a method or code on a computer readable medium (i.e. a substrate). The computer readable medium is a tangible data storage device that can store data, which can thereafter, be read by a computer system. Examples of a computer readable medium include read-only memory, random-access memory, CD-ROMs, magnetic tape, optical data storage devices and the like. The computer readable medium may be geographically localized or may be distributed over a network coupled computer system so that the computer readable code is stored and executed in a distributed fashion.

In a certain example, a computer program stored on one or more non-transitory computer readable media may be executed to facilitate a credit redemption. A computer readable medium embodying a computer program for facilitating a credit redemption includes: computer program code for storing a plurality of user records, each user record comprising a user identifier and a quantity of credits allocated to the user and at least one score relating to the user's social network influence; computer program code for storing a plurality of sponsor records, each sponsor record comprising a sponsor identifier, a quantity of sponsor-purchased credits and at least one score relating to the sponsor's social network influence; computer program code for receiving from a user a redemption offer for a quantity of credits held in the user's account, the redemption offer open for bids from at least one sponsor; and computer program code for performing a valuation analysis of the redemption offer to determine an adjusted value for the quantity of credits based on at least one user score and returning the adjusted value to the user and/or the at least one sponsor prior to prompting a bid from the at least one sponsor. Aspects of the computer readable medium embodying a computer program may be further defined in several illustrative examples. In one example, the valuation analysis may also consider at least one sponsor score. In another example, the redemption offer is open for bids from a plurality of sponsors. When the redemption offer is open for bids from a plurality of sponsors, the user may be allowed to specify and/or select the plurality of sponsors. In another example, the valuation analysis considers at least one user score and at least one sponsor score for each possible pairing of the user with each of the plurality of sponsors selected by the user; optionally, the adjusted value for each user and sponsor pairing may be returned to all of the plurality of sponsors selected by the user. In another example, the adjusted value is formatted as an absolute value, a multiple, a percentage, or a differential. In another example, the user score is determined based on a plurality of user-centric parameters extracted from one or more of user action history, credit transaction history, and user social networking history. In another example, the user score is based on user interaction with first order and second order neighboring nodes in a social network graph. In another example, the user score is a simple moving average of a plurality of user scores previously generated and recorded at regular intervals. In another example, the user score is based on information obtained from a plurality of social networks. In another example, the user score is bound by a range with an upper limit and a lower limit. In another example, the sponsor score is determined based on a plurality of sponsor-centric parameters extracted from one or more of credit transaction history, sponsor credit purchase history, sponsor credit allocation history, sponsor social networking history, and sponsor website traffic.

Embodiments described herein are intended for illustrative purposes without any intended loss of generality. Still further variants, modifications and combinations thereof are contemplated and will be recognized by the person of skill in the art. Accordingly, the foregoing detailed description is not intended to limit scope, applicability, or configuration of claimed subject matter.

What is claimed is:

1. A scalable networked computing system for scoring social influence in an Internet-based social network, comprising:
a storage system for storing a plurality of user records and a plurality of sponsor records, each user record comprising a user identifier, a quantity of credits allocated to the user and at least one score relating to the user's social network influence, and each sponsor record comprising a sponsor identifier, a quantity of sponsor-purchased credits, criteria for allocating credits to users and at least one score relating to the sponsor's social network influence;
a treasury component, communicative with the storage system, configured to update the quantity of sponsor-purchased credits in each sponsor record in response to receiving a credit purchase request from a sponsor identified in the sponsor record;
a sponsorship manager component, communicative with the storage system, configured to allocate sponsor-purchased credits to add to the quantity of allocated credits in each user record based on corresponding user actions in a social network;
a networked interface device for receiving, from a user computing device communicative with the networked interface device through the Internet, a redemption offer for a quantity of credits held in the user's account, the redemption offer open for bids from at least one sponsor; and
a processor, communicative with both the storage system and the networked interface device, for performing a valuation analysis of the redemption offer to determine an adjusted value for the quantity of credits based on at least one user score and returning the adjusted value to the user and/or the at least one sponsor prior to prompting a bid from the at least one sponsor.

2. The system of claim 1, wherein the valuation analysis considers at least one sponsor score.

3. The system of claim 1, wherein the redemption offer is open for bids from a plurality of sponsors, the plurality of sponsors are selected by the user, and the valuation analysis considers at least one user score and at least one sponsor score for each possible pairing of the user with each of the plurality of sponsors selected by the user.

4. The system of claim 1, wherein the at least one user score is determined based on a plurality of user-centric parameters extracted from one or more of user action history, credit transaction history, and user social networking history; and the at least one user score is based on information obtained from a plurality of social networks.

5. The system of claim 1, wherein the at least one user score is based on user interaction with first order and second order neighboring nodes in a social network graph; and the at least one user score is based on information obtained from a plurality of social networks.

6. The system of claim 2, wherein the at least one sponsor score is determined based on a plurality of sponsor-centric parameters extracted from one or more of credit transaction history, sponsor credit purchase history, sponsor credit allocation history, sponsor social networking history, and sponsor website traffic; and the at least one sponsor score is based on information obtained from a plurality of social networks.

7. A method for scoring social influence in an Internet-based social network, comprising:
storing a plurality of user records, each user record comprising a user identifier and a quantity of credits allocated to the user and at least one score relating to the user's social network influence;
storing a plurality of sponsor records, each sponsor record comprising a sponsor identifier, a quantity of sponsor-purchased credits, criteria for allocating credits to users and at least one score relating to the sponsor's social network influence;
updating the quantity of sponsor-purchased credits in each sponsor record in response to receiving a credit purchase request from a sponsor identified in the sponsor record;
allocating sponsor-purchased credits to add to the quantity of allocated credits held in each user record based on corresponding user actions in a social network;
receiving from a user a redemption offer for a quantity of credits held in a user record, the redemption offer open for bids from at least one sponsor; and
performing a valuation analysis of the redemption offer to determine an adjusted value for the quantity of credits based on at least one user score and returning the adjusted value to the user and/or the at least one sponsor prior to prompting a bid from the at least one sponsor.

8. The method of claim 7, wherein the valuation analysis considers at least one sponsor score.

9. The method of claim 7, wherein the redemption offer is open for bids from a plurality of sponsors, the plurality of sponsors are selected by the user, and the valuation analysis considers at least one user score and at least one sponsor score for each possible pairing of the user with each of the plurality of sponsors selected by the user.

10. The method of claim 7, wherein the at least one user score is determined based on a plurality of user-centric parameters extracted from one or more of user action history, credit transaction history, and user social networking history; and the at least one user score is based on information obtained from a plurality of social networks.

11. The method of claim 7, wherein the at least one user score is based on user interaction with first order and second order neighboring nodes in a social network graph; and the at least one user score is based on information obtained from a plurality of social networks.

12. The method of claim 8, wherein the at least one sponsor score is determined based on a plurality of sponsor-centric parameters extracted from one or more of credit transaction history, sponsor credit purchase history, sponsor credit allocation history, sponsor social networking history, and sponsor website traffic; and the at least one sponsor score is based on information obtained from a plurality of social networks.

13. A non-transitory computer readable medium embodying a computer program for scoring social influence in an Internet-based social network, comprising:
computer program code for storing a plurality of user records, each user record comprising a user identifier and a quantity of credits allocated to the user and at least one score relating to the user's social network influence;
computer program code for storing a plurality of sponsor records, each sponsor record comprising a sponsor identifier, a quantity of sponsor-purchased credits, criteria for allocating credits to users, and at least one score relating to the sponsor's social network influence;
computer program code for updating the quantity of sponsor-purchased credits in each sponsor record in response to receiving a credit purchase request from a sponsor identified in the sponsor record;
computer program code for allocating sponsor-purchased credits to add to the quantity of allocated credits held in each user record based on corresponding user actions in a social network;
computer program code for receiving from a user a redemption offer for a quantity of credits held in the user's account, the redemption offer open for bids from at least one sponsor; and
computer program code for performing a valuation analysis of the redemption offer to determine an adjusted value for the quantity of credits based on at least one user score and returning the adjusted value to the user and/or the at least one sponsor prior to prompting a bid from the at least one sponsor.

14. The computer readable medium of claim 13, wherein the valuation analysis considers at least one sponsor score.

15. The computer readable medium of claim 13, wherein the redemption offer is open for bids from a plurality of sponsors, the plurality of sponsors are selected by the user, and the valuation analysis considers at least one user score and at least one sponsor score for each possible pairing of the user with each of the plurality of sponsors selected by the user.

16. The computer readable medium of claim 13, wherein the at least one user score is determined based on a plurality of user-centric parameters extracted from one or more of user action history, credit transaction history, and user social networking history; and the at least one user score is based on information obtained from a plurality of social networks.

17. The computer readable medium of claim 13, wherein the at least one user score is based on user interaction with first order and second order neighboring nodes in a social network graph; and the at least one user score is based on information obtained from a plurality of social networks.

18. The computer readable medium of claim 14, wherein the at least one sponsor score is determined based on a plurality of sponsor-centric parameters extracted from one or more of credit transaction history, sponsor credit purchase history, sponsor credit allocation history, sponsor social networking history, and sponsor website traffic; and the at least one sponsor score is based on information obtained from a plurality of social networks.
